(19) United States
(12) Patent Application Publication
(10) Pub. No.: US 2013/0216811 A1
(43) Pub. Date: Aug. 22, 2013

(54) NANOTAPE AND NANOCARPET MATERIALS

(71) Applicants: Mohammed Naghi Ghasemi-Nehjad, Honolulu, HI (US); Vamshi M. Gudapati, Honolulu, HI (US)

(72) Inventors: Mohammed Naghi Ghasemi-Nehjad, Honolulu, HI (US); Vamshi M. Gudapati, Honolulu, HI (US)

(73) Assignee: University of Hawaii, Honolulu, HI (US)

(21) Appl. No.: 13/520,878

(22) PCT Filed: Jan. 6, 2011
(86) PCT No.: PCT/US11/20360

§ 371 Date: Jan. 10, 2013

Related U.S. Application Data
(60) Provisional application No. 61/335,532, filed on Jan. 7, 2010.
(60) Provisional application No. 61/339,733, filed on Mar. 5, 2010.

(51) Int. Cl. B32B 37/16

(52) U.S. Cl. CPC B32B 37/16
USPC 428/220; 428/221; 442/181; 156/60; 264/334; 156/246

(57) ABSTRACT

Provided are nanostructure-containing nanotape materials. The materials may be incorporated at the interface between two other structures to provide strength and toughness at the interface. The materials may also be applied to a standalone structure to provide strength and toughness. Also provided are related methods of fabricating the nanotape materials, as well as gas diffusion membranes and fuel cells that include nanostructured materials.

### RELATED APPLICATIONS

This application claims the benefit of U.S. Application No. 61/339,733, “HF Replacement and Continuous Rolling Production,” filed on Mar. 5, 2010, and of U.S. Application No. 61/335,532, “Development of Novel Carbon-Nanotube-Based Nanocarpet-Nanotapes for High-Performance Hierarchical Multifunctional Nanocomposites,” filed on Jan. 7, 2010. These applications are incorporated herein by reference in their entireties for any and all purposes.

### STATEMENT OF GOVERNMENT RIGHTS

This invention was made with government support under Office of Naval Research (ONR) Grant N00014-07-1-0889. The government has certain rights in the invention.

### TECHNICAL FIELD

The present application relates to the field of nanotechnology and to the field of composite materials.

### BACKGROUND

Developments in nanomaterials have created new, nanocomposite materials useful in a variety of different applications. While parts made from such composite materials present improvements over older materials, the interface between two regions of a composite part may be a weak point in the part. Regions may be bonded at their interface in a variety of ways, but these interfaces may also fail at different locations and in various failure modes.

First, composites may include regions bound by an adhesive. When composites are made by using adhesives to bond two parts, failure can occur in the adhesive or in the adherent. This failure may depend on the geometry of the composite, on the materials of the regions being bound, on the adhesive itself, and on the bonding process itself.

Parts may also be joined by mechanical fasteners. To use mechanical fasteners, one normally introduces a “cut-out,” such as a circular hole, into the structure to accommodate the fastener. The presence of such holes, however, introduces stress concentrations in the affected materials. Such stresses can lead to failure of the composite part. Accordingly, there is a need for improved composite materials.

### SUMMARY

Provided first are methods of fabricating a composite material. These methods include disposing nanostructures having major axes onto a support surface, removing from the surface a film comprising at least some of the nanostructures; aligning at least some of the nanostructures of the film such that the major axes of the aligned nanostructures are substantially parallel to the plane of the film, and positioning the film atop a first surface; and affixing the first surface to a second surface to form an interface between the first and second surfaces, the interface comprising the film of nanostructures.

Also disclosed are methods of fabricating a composite article. These methods include positioning a film of nanostructures having major axes between a first surface and a second surface, the major axes aligned essentially parallel to the plane of the film; and affixing the first and second surfaces to one another to form an interface between the first and second surfaces, the interface comprising the film of nanostructures.

Further provided are composite articles, the articles comprising a film of nanostructures having major axes disposed at the interface between a first surface and a second surface, the major axes of the nanostructures being aligned substantially parallel to the plane of the film.

Additionally disclosed are composite articles, the articles comprising a body having a surface at least partially surmounted by a film, and the film comprising a plurality of nanostructures having major axes oriented substantially parallel to plane of the film.

Also provided are methods of fabricating a nanostructure film, comprising growing nanostructures having major axes on a support substrate so as to give rise to a population of nanostructures; removing from the support substrate a film comprising at least some of the nanostructures; and aligning at least some of the nanostructures of the film such that the major axes of the aligned nanostructures are substantially parallel to the plane of the film.

Reinforcement materials are, also disclosed. The materials suitably include a film of nanostructures having major axes, the major axes aligned essentially parallel to the plane of the film.

Diffusion membranes are also disclosed. The membranes include a permeable support film at least partially surmounted by a film of nanostructures.

Method of fabricating diffusion layers are also disclosed. The methods include disposing a film of nanostructures having major axes atop a surface of a support membrane, the major axes being oriented essentially perpendicular to the plane of the support membrane.

Also disclosed are fuel cells. The fuel cells suitably include a proton exchange membrane; an anode gas diffusion layer in contact with the anode catalyst layer; an anode catalyst layer in contact with the anode gas diffusion layer and the proton exchange membrane; a cathode catalyst layer in contact with the proton exchange membrane and the cathode gas diffusion layer; and a cathode gas diffusion layer, at least one of the anode gas diffusion layer and the cathode gas diffusion layer being at least partially surmounted by a film of nanostructures having major axes oriented essentially perpendicular to the plane of the anode gas diffusion layer or the cathode gas diffusion layer.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 depicts a schematic of an exemplary chemical vapor deposition system for the growth of carbon nanotubes;

FIG. 2 depicts a schematic of an alternative chemical vapor deposition system for the growth of multi-walled carbon nanotubes;

FIG. 3 illustrates a chemical vapor deposition system for the growth of multi-walled carbon nanotubes;

FIG. 4 is an SEM image of the vertically aligned high density arrays of MWCNTs grown over silicon and silicon oxide wafer using a CVD process;

FIG. 5 is (right and left) two TEM images of the individual multi-walled carbon nanotubes synthesized by a CVD process;

FIG. 6 is an exemplary graph of molar fraction of Fe catalyst versus HCl reaction time for an exemplary nanotube-nanofilm process;

FIG. 7 illustrates EM Images of: (a) low magnification bottom surface, (b) Medium magnification bottom surface, (c) high magnification bottom surface, and (d) high magnification top surface;

FIG. 8 illustrates an exemplary press-rolling technique to produce nanotapes from VA-CNT-NFs;

FIG. 9 illustrates high magnification SEM Images of: (a) crushed CNTs with random alignment, (b) random alignment, (c) partial horizontal alignment, and (d) horizontal alignment;

FIG. 10 illustrates a SEM image showing a fully horizontal alignment of the CNTs (the alignment axis in this image is in the diagonal direction—from bottom left to top right);

FIG. 11 illustrates an SEM image showing a fully horizontal alignment of the CNTs (the alignment axis in this image is in the diagonal direction—from top right to bottom left);

FIG. 12 illustrates an SEM image showing a fully horizontal alignment of the CNTs (the alignment axis in this image is in the horizontal direction from left to right);

FIG. 13 illustrates a SEM image showing a cross section of nanotape inside a composite specimen;

FIG. 14 is a SEM image of a composite with nanotape embedded fracture surface showing a fully horizontal alignment of the CNTs (the alignment axis in this image is in the fiber longitudinal and the image diagonal direction—from bottom right to top left);

FIG. 15 is a SEM image of a composite with nanotape embedded fracture surface showing a fully horizontal alignment of the CNTs (the alignment axis in this image is in the fiber transverse direction—from right to left);

FIG. 16 is a schematic of vertically stacked VA-CNT-NFs on a single substrate for mass-Production;

FIG. 17 is an image of two exemplary pieces of purified VA-CNT-NFs;

FIG. 18 is an image of two exemplary pieces of purified VA-CNT-NFs, the pieces slightly overlapped at the edges, placed in between Teflon™ films, and placed on a bottom aluminum plate;

FIG. 19 illustrates the VA-CNT-NFs/Teflon™ films/aluminum plate assembly of FIG. 18 going through a rolling machine;

FIG. 20 illustrates a continuous nanotape made of four exemplary pieces of purified VA-CNT-NFs, inside Teflon™ films;

FIG. 21 illustrates the continuous nanotape of FIG. 20, inside the Teflon™ films, as a typical continuous nanotape, rolled over a spool;

FIG. 22 illustrates how a four-piece stitching, presented here, can be extended to much larger number of pieces to produce large quantity of nanotapes placed in between films and rolled over spools for bulk shipment;

FIG. 23 illustrates how a nanotape can be placed on a composite lay up (either a wet lay-up or a prepreg);

FIG. 24 illustrates an exemplary developmental chart for hierarchical nanocomposites;

FIG. 25 (a) depicts a schematic of a nanocarpet-nanotape hierarchical nanocomposite, (b) depicts the interlaminar distance between two plies of a base composite without nanotape, where the inset shows a nanocomposite where the interlaminar distance is filled with a nanotape, (c) shows dimension of a single carbon fiber as compared with well aligned horizontal carbon nanotubes within the nanotape.

FIG. 26 depicts a DCB (double cantilever beam) specimen side view and top view;

FIG. 27 illustrates a thermoset cycle employed for the cure of an exemplary composite in a wet lay-up;

FIG. 28 illustrates crack elongation from a debond in a DCB test;

FIG. 29 illustrates load versus displacement for base and CNT nanotape composite laminates in wet lay-up;

FIG. 30 compares the R curves of pristine and CNT nanotape nanocomposite for wet lay-up;

FIG. 31 illustrates a DCB fracture surface of a nanotape composite made by wet lay-up at a lower resolution;

FIG. 32 illustrates a DCB fracture surface of the nanotape composite made by wet lay-up at a higher optical resolution;

FIG. 33 depicts (a) prepreg with nanotape (average 60 micrometers) in place, during the manufacturing lay-up, (b) prepreg with VA-CNT-NFs (average 60 micrometers) in place, during the manufacturing lay-up;

FIG. 34 depicts the thermoset cycle employed for the cure of composite for prepreg;

FIG. 35 illustrates load versus displacement for base and CNT nanotape composite laminates for prepreg;

FIG. 36 illustrates a comparison between R curves of pristine and CNT nanotape composite for a prepreg;

FIG. 37 illustrates (a) DCB fracture surface of the pristine composite by prepreg with low resolution, (b) DCB fracture surface of the pristine composite by prepreg with high resolution;

FIG. 38 illustrates (a) DCB fracture surface of the VA-CNT-NFs nancomposite by prepreg with high resolution and (b) DCB fracture surface of the nanotape nancomposite by prepreg with high resolution;

FIG. 39 illustrates exemplary shear load vs. deflection curve from a short beam shear test;

FIG. 40 illustrates exemplary shear load vs. deflection curve from short beam shear test of prepreg;

FIG. 41 illustrates (a) an optical micrograph of a fracture surface of base SBS sample, (b) an optical micrograph of a fracture surface of dry nanotape SBS sample, (c) an optical micrograph of a fracture surface of wet nanotape SBS sample;

FIG. 42 illustrates exemplary load vs. extension curves from tension samples;

FIG. 43 illustrates (a) exemplary flexure load vs. deflection curve from flexure samples, (b) exemplary stress vs. strain curve from flexure samples;

FIG. 44 illustrates a structural dynamic analysis of the composite specimens, showing typical amplitude versus frequency plot from the experiment—inset: experimental setup for measuring the natural frequency and damping ratio of composite specimens;

FIG. 45 illustrates (a) time vs. amplitude recordings for base composite, (b) Time vs amplitude recordings for nanotape nanocomposite;

FIG. 46 illustrates (a) silicon substrate with vertically aligned CNT growth to give nanofilms, (b) SEM image of aligned CNT nanofilm growth;

FIG. 47 illustrates (a) a schematic of samples used for shear test using ASTM-D5868, (b) actual shear test sample with the MWCNT nanofilm.

FIG. 48 is a SEM image showing aligned MWCNT nanofilm with a thin layer of Fe catalyst on top;

FIG. 49 illustrates (a) exemplary fracture surface observed for sample with pure resin, (b) typical fracture surface observed for sample with resin reinforced by vertically aligned MWCNT nanofilm;

FIG. 50 illustrates a load displacement curve for adhesive shear strength samples;

FIG. 51 illustrates a SEM image of fracture surfaces of (a) pure adhesive low magnification, (b) pure adhesive high magnification, (c) VA-CNT-NFs low magnification, (d) VA-CNT-NFs film low magnification, (e) AVA-CNT-NFs high magnification, (f) nanotape film low magnification, and (g) high magnification nanotape film;

FIG. 52 illustrates (a) prepregs used for manufacturing base/nanotape composite, (b) base composite with un-notched hole, (c) base composite with drilled hole (right), nanotape composites with drilled hole (left);

FIG. 53 illustrates exemplary load vs. displacement curves for un-notched/drilled in composite samples;

FIG. 54 illustrates (a) VA-CNT-NF on silicon oxide substrate immersed in Alumiprep 33, (b) VACNT-NF samples etched from silicon oxide substrate using Alumiprep 33.

FIG. 55 depicts an exemplary elastic curve for mill spring and plastic curve for rolled material with initial thickness h1 and rolled thickness h2 with initial roll gap S₀;

FIG. 56 depicts a schematic of replacing aluminum plates with tough flexible metallic sheets for the rolling process;

FIG. 57 illustrates a continuous rolling process sandwiching VA-CNT-NFs between Teflon™ films and then, in turn, in between the rolling aluminum sheets to continuously produce nanotapes.

FIG. 58 depicts a vacuum bagging sequence for AS4/977-3 unidirectional prepreg.

FIG. 59 depicts a curing profile for composite laminate made from AS4/977-3 prepreg.

FIG. 60 illustrates thermal expansion for a base sample in x-direction.

FIG. 61 illustrates thermal expansion for a nanotape-modified sample in x-direction

FIG. 62 illustrates thermal expansion for a base sample in z-direction.

FIG. 63 illustrates thermal expansion for a nanotape-modified sample in z-direction

FIG. 64 illustrates EMI shielding effectiveness (SE) of Base, Modified 1, and Modified 2 Samples.

FIG. 65 illustrates a prepreg;

FIG. 66 illustrates one quarter of a 4-inch circular wafer transferred onto prepreg;

FIG. 67 illustrates a full 4-inch circular wafer transferred onto prepreg;

FIG. 68 depicts multiple, square wafers transferred onto prepreg side-by-side employing an automated/robotic system to cover the entire surface of the prepreg with the MWCNT-based nanocarpet-nanotapes;

FIG. 69 illustrates a grown, vertically aligned MWCNT nanoforest nanofilm (VA-CNT-NF) with a thin layer of Fe catalyst film (shown at the top of the figure, which is in fact the bottom of the nanofilm grown on the substrate, shown here upside down);

FIG. 70 illustrates SEM images of (a) low magnification, bottom surface; (b) medium magnification, bottom surface; (c) high magnification, bottom surface; and (d) high magnification, top surface;

FIG. 71 illustrates SEM images showing the surface morphology of (a) as-received carbon paper versus (inset shows a close-up of bare carbon fibers) and (b) in situ modified carbon paper;

FIG. 72 illustrates SEM images showing the surface morphology of (a) as-received carbon paper versus (b) modified carbon paper using VA-CNT-NF technology;

FIG. 73 illustrates contact angle vs. droplet volume on different GDLs with water;

FIG. 74 illustrates contact angle vs. droplet volume on different GDLs with diiodomethane; and

FIG. 75 illustrates peak power density for various gas diffusion layers in (a) H₂/O₂ and (b) H₂/Air.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Provided first are, generally, a new class of nano-reinforcements (referred to as nanocarpet-nanotape) useful in reinforcing (for strengthening as well as toughening) a variety of structures, including:

(1) standard resins (e.g., thermosetting, thermoplastic, or preceramic polymer): by reinforcing the resin to produce nanocomposites with improved properties relative to the unreinforced resin;

(2) composite systems: by interleaving the reinforcement within regular continuous fiber composite (for virtually any type of fiber materials, including carbon, glass, Kevlar™, Spectra™, silicon carbide, alumina, etc. or a hybrid/combination of them and for any kind of fiber architecture.

The composite may be unidirectional, 2D woven, 3D triaxial/braided, and the like, and the invention maybe applied to wet lay-up or prepreg-based polymers to produce high-performance nanocomposites;

(3) adhesives: by reinforcing adhesives for joining two adherents to locally reinforce to strengthen and toughen the regions of stress concentrations;

(4) at and around the joint areas and cut-outs (such as holes) and where mechanical fasteners are needed for composites to locally reinforce to strengthen and toughen the regions of stress concentrations

The disclosed methods are applicable to a variety of polymer composite manufacturing techniques. Such techniques include, inter alia, room temperature cure, autoclave cure, compression molding, resin transfer molding (RTM), open or closed mold vacuum assisted resin transfer molding (VARTM), reaction injection molding (RIM), structural reaction injection molding (SRIM), elastic reservoir molding (ERM), sheet molding compound (SMC), manual or automated and wet lay-up or prepreg role wrapping, co-cured sandwiched structures, pultrusion, manual or automated and wet lay-up or prepreg tape laying, in-situ (on-line consolidation) thermoplastic composites tape laying, filament winding by in-situ (on-line consolidation) thermoplastic composites tape laying, diaphragm forming, matched die forming, hydroforming, thermoforming, and the like.

The methods are also applicable to virtually any geometry, whether flat, curved, contoured, and multi-curvatures, and can be applied locally (i.e., around certain regions where the properties need to be improved locally) or globally (i.e., for the entire structure, where the properties need to be improved globally and everywhere in the structure).

The disclosed reinforcements and methods impart improved properties on materials, the improvement being physical, chemical, mechanical (static—strength, stiffness, strain, toughness; and dynamic—fatigue, impact, damping, etc.), electrical, thermal, and the like.

These improvements can be isotropic or anisotropic depending on the orientation of the fibers and the nanocarpet or nanotape. Interleaving of nanocarpet-nanotape within the layered structures can be sequential and in between all the layers, or alternating with a certain period or spacing of layers, or placed only within some layers.

In one aspect, provided first are methods of method of fabricating a composite material. These methods include disposing nanostructures having major axes onto a support surface and removing from the support surface a film comprising at least some of the nanostructures. The user may then align at least some of the nanostructures of the film such that the major axes of the aligned nanostructures are substantially parallel to the plane of the film, and position the film atop a first surface.

As one non-limiting embodiment—described in additional detail elsewhere herein—the user may grow carbon nanotubes or other nanostructures atop a silicon substrate, and then applies a mechanical force so as to flatten or render the nanotubes horizontal. Carbon nanotubes are particularly suitable for the disclosed applications.

The user also suitably affixes the first surface to a second surface to form an interface between the first and second surfaces, with the interface comprising the film of nanostructures. In some embodiments, the user may simply place the film between the two surfaces and press the surfaces together. In other configurations, the user may disposed the film within an adhesive that is in turn placed at the interface of the two surfaces. Adhesives may be glues, polymers, and the like; polymers (e.g., polystyrene, epoxy, PMMA, PVA, PVP, and the like) or other materials may be infiltrated/coated/applied to the nanostructures. The user may apply heat, vibration, ultrasound, pressure, and the like to promote bonding between the surfaces.

A variety of materials may be used as support surfaces. Silicon oxide, quartz, and other oxide materials may be used for the support surface. The disposition of the nanostructures may be effected by synthesizing the nanostructures atop the support surface. In one especially suitably embodiment, the user may grow a population of nanotubes (which population may be referred to as a “forest”) atop a silicon oxide surface. Such nanotube growth is described herein in additional detail.

Various nanostructures may be used in the disclosed methods. Carbon (single, multiwall, or both) nanotubes are considered especially suitable, as such nanotubes exhibit useful mechanical and electrical properties.

Nanofibers (suitably those having a diameter of less than about 1500 or about 1000 nm) are also considered suitable nanostructures. Such fibers may be made from carbon, titanium dioxide (TiO₂), silicon dioxide (SiO₂), zirconium dioxide (ZrO₂), aluminum oxide (Al₂O₃), lithium titanate (Li₄Ti₅O₁₂), titanium nitride (TiN), platinum (Pt), and the like. The nanofibers may have a length in the range of nanometers, tens of nanometers, hundreds of nanometers, micrometers, or even tens of micrometers.

Nanosheets—nanoscale flake bodies—may also be used as nanostructures in the methods. Nanoparticles may also be used. Such nanoparticles may be spherical in configuration, oblong, or even polygonal.

A nanostructure suitably has at least one cross-sectional dimension (e.g., diameter, width, length) in the range of from about 1 nm to about 200 nm or even 500 nm, or from about 5 nm to about 100 nm, or even from about 20 nm to about 50 nm. The major axis of a nanostructure may be defined as the axis of the longest cross-sectional dimension of the nanostructure. For example, in the case of a cylindrical nanotube, the major axis is the height (or length) of the nanotube. In the case of an oblong nanoparticle, the major axis would be the longest cross-sectional dimension of the nanoparticle.

The major axis of the nanostructure may be in the range of nanometers, tens of nanometers, hundreds of nanometers, or even in the micrometer or tens of micrometers range. Nanostructure bodies having a major axis in the range of 1 to 100 micrometers are considered especially suitable, although larger or smaller bodies may also be used.

Nanostructures may be disposed on the substrate by synthesizing or growing the nanostructures in place on the support surface or substrate. This may be accomplished—as described elsewhere herein in additional detail—by synthesizing or assembling the structures (e.g., carbon nanotubes) atop the support surface in place. Nanostructures may also be disposed on the substrate by spraying, casting, precipitating, or by other methods known in the art.

In some embodiments, the surface includes comprises a catalyst, which catalyst may be selected to promote nanostructure growth. The catalyst may be nickel, iron, cobalt, copper, gold, a transition metals, and the like. Combinations of materials may be used as catalysts. The optimal catalyst for a particular nanostructure will be known by those of ordinary skill in the art without undue experimentation.

In the non-limiting embodiment where carbon nanotubes or other nanostructures are grown on the support surface, the user may apply a carbon-containing fluid or other starting material under processing conditions suitable to grow nanotubes. This carbon-containing fluid may be xylene or other nanotube starting material, such as methane or other gas. A mixture of starting materials may also be used. Suitable catalysts include iron (Fe), but may also include nickel, cobalt, and the like. Inert gases, such as argon, helium, or nitrogen, may also be used during the process as carriers for other materials (e.g., xylene, catalyst)

As illustrated herein, the user may the remove from the surface a film that includes at least some of the nanostructures. This removing may be effected by, e.g., application of hydrofluoric acid, phosphoric acid, and the like. Alumiprep™ (from Henkel), Ceramic Etchant A™ from Sigma-Aldrich, and Eco-Etch™ are suitable for effecting film removal; one such product is at http://www.chemical-supermarket.com/product.php?productid=365. Removal may also be accomplished by application of mechanical force, such as scraping, peeling, and the like.

The film may be cleaned so as to remove any impurities. Water, buffer, or other fluids may be used to cleanse the film.

Catalyst material present on the film may also be removed. This may be accomplished by application of HCl or other etchant, followed by rinsing with distilled water and drying.

The nanostructures may be aligned by application of mechanical force. This force may be applied by a press, a roller, and the like. Rollers are considered especially suitable sources of pressure, as roller application enables continuous, large-scale production of nanotapes. Additional detail regarding rollers is provided further herein.

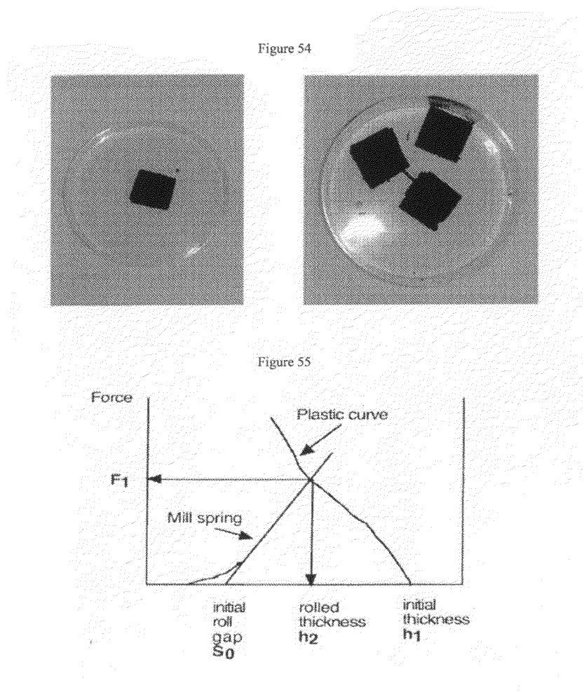

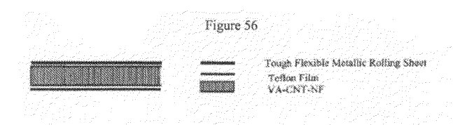

Sheets or plates may be placed between the roller (or other source of mechanical force) and the film. These sheets may be of steel, aluminum, or other suitable material; aluminum is considered especially suitable. Flexible metallic sheets—as depicted in FIG. 56—may also be used. As shown in that figure, an assembly of a vertically-oriented film of nanostructures may be disposed between flexible metallic rolling sheets. Further information concerning the selection of sheets or plates is provided elsewhere herein.

A protective sheet (e.g., Teflon™) may be positioned adjacent to the surface of the nanostructure film during processing. This protective sheet may be used to insulate the film against the exterior environment, and may be removed before affixing the first surface to the second surface. Besides Teflon™, other suitable protective sheet materials include Kapton™, polyimides, polypropylene, polyethylene, and the like.

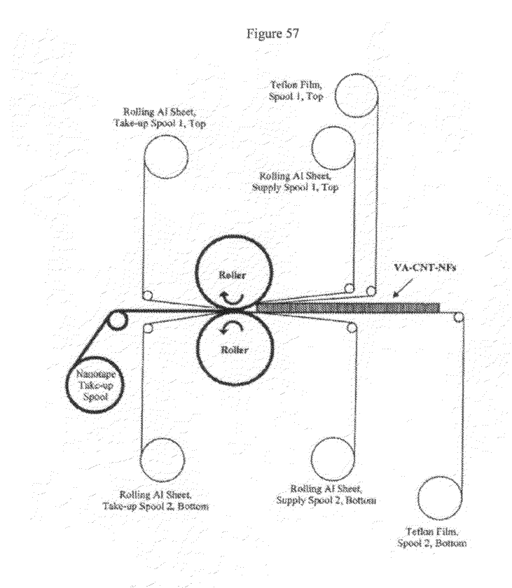

The film may be positioned adjacent to the film by application of pressure, curing a polymer present at the interface, or other method of affixation. FIGS. 8 and 57 illustrate non-limiting schemes for manufacturing the disclosed materials. These figures illustrate the application of force to vertically-aligned carbon nanotubes so as to orient the nanotubes in a horizontal orientation, giving rise to a nanotape or nanocarpet structure. (Materials that include nanotape or nanocarpet may be referred to as nanocomposites.)

Films or nanotapes may be applied to virtually any type of surface. A surface may be a fiber, a prepreg, a weave, triaxial, tow, tape, mat, a braid, and the like. A surface may be porous or pitted. The surface need not necessarily be planar, as the film may be applied so as to conform to a non-planar surface. The surface may also be a sheet or segment of another material. Multiple layers of nanotape material may be applied to a surface. As described elsewhere herein, multiple layers of nanostructures may also be grown atop a surface, as well.

Other methods of fabricating composite articles are also provided. These methods include positioning a film of nanostructures having major axes between a first surface and a second surface, the major axes being aligned essentially parallel to the plane of the film. The user then affixes the first and second surfaces to one another to form an interface between the first and second surfaces, the interface comprising the film of nanostructures.

A nanostructure includes, as described elsewhere herein, a nanotube, a nanosheet, a nanofiber, and the like. The methods encompass the use of a single kind of nanostructure (e.g., carbon nanotubes of a specific size) or a mixture of nanostructures that differ in size, composition, or both.

The film may include upper and lower protective layers, which layers are suitably removed before the first and second surfaces are affixed. The protective layers may be polytetrafluoroethylene or other suitable polymer material. The surfaces may, as described elsewhere herein, include a fiber, a prepreg, a weave, triaxial, tow, tape, mat, braid, and the like. Plates or other flat surfaces are also suitable.

The films may be used to bond disparate materials to one another, i.e., the surface being bonded need not themselves be of the same material. This in turn enables the user to bond different materials to one another, which allows construction of composite materials that are themselves composed of different materials. For example, one may use the disclosed nanotapes to bond a flexible material (e.g., a fiber) to a less-flexible (e.g., a polymer body). The user may also bond different kinds of fibers to one another. The user may also create structures that have a flexible region that is bonded to one or more rigid regions.

The major axes of the nanostructure are suitably parallel to the plane of the film, but they need not be completely parallel to the film's plane. Nanostructures may be aligned such that they are inclined relative to the plane of the film; such inclination may be 1 degree, 5 degrees, 10 degrees, 20 degrees, 30 degrees, or even more inclination. Not all nanostructures need have the same degree of inclination; some portions of a film (i.e., nanotape) may include nanostructures that are inclined at 5 degrees, while other portions of a film may include nanostructures that are inclined at 2 degrees.

Composite articles are also provided. These materials include a film of nanostructures, having major axes, disposed at the interface between a first surface and a second surface. The major axes of the nanostructures are suitably aligned substantially parallel to the plane of the film. As explained above, however, the major axes need not always be entirely parallel to the plane of the film, and the major axes may in fact be inclined relative to the plane of the film.

A nanostructure may include a nanosheet, a nanofiber, and other suitable materials described elsewhere herein in additional detail. Carbon nanotubes are considered especially suitable for use as nanostructures in the disclosed articles.

The film of aligned nanostructures suitably defines a thickness in the range of from about 1 micrometer to about 500 micrometers, or in the range of from about 10 micrometers to about 200 micrometers, or in the range of from about 20 micrometers to about 50 micrometers. A thickness of from about 20 micrometers to about 60 micrometers is considered especially suitable for films that bond two surfaces to each other. Film thicknesses in the range of nanometers, tens of nanometers, or even hundreds of nanometers are also suitable.

The composite articles may include a variety of surfaces and materials. The article may have a film in contact with a fiber, a prepreg, a weave, textile, tow, tape, mat, a braid, and the like. The surface suitably comprises a polymer, but polymeric surfaces are not necessary. The articles may include sheets of materials (e.g., a fabric) that include the nanostructure films at their interfaces.

The major axes of the nanostructures are suitably aligned such that they are essentially parallel to the first surface, the second surface, or both. Parallel alignment is not required; as explained elsewhere herein, the nanostructures may be inclined relative to the surface. The nanostructure film may have one or more nanostructures being at least partially embedded in the first surface, the second surface, or both.

As shown in the attached examples, the incorporation of the nanostructure film imparts improved properties to the composite article. Such incorporation suitably imparts at least one of an improved thermal conductivity, an improved mechanical strength, an improved mechanical toughness, an improved damping, a reduced coefficient of thermal expansion, and improved shielding of electromagnetic interference relative to an essentially identical composite article lacking the film of nanostructures, under essentially identical conditions.

Further provided are composite articles. Such articles include a body having a surface at least partially surmounted by a film, the film comprising a plurality of nanostructures having major axes oriented substantially parallel to plane of the film. Suitable nanostructures are described elsewhere herein; carbon nanotubes are considered especially suitable.

The film may define a thickness of from about 1 to about 500 micrometers, or from about 10 to about 100 micrometers, or from 30 to about 80 micrometers, or even from about 40 to about 70 micrometers. The film may surmount only a portion of the body. Alternatively the film may surmount the entire body, in the manner of a wrap or envelope. Layers or tapes of the nanostructure films may be wound, spun, wrapped, or otherwise applied to a body. Multiple layers of film may be applied to a body.

In some embodiments, essentially the entire surface area of the body is surmounted by the film; in other embodiments, than about 90% of the surface area of the body is surmounted by the film, less than about 70% of the surface area of the body is surmounted by the film, less than about 50% of the surface area of the body is surmounted by the film, than about 30% of the surface area of the body is surmounted by the film, or even less than about 10% of the surface area of the body is surmounted by the film. In some embodiments, one may characterize the body as being wrapped by the film.

Bodies may be fibers, a prepreg, a weave, textile, tow, tape, mat, braids, and the like. The body may be polymeric in nature. The body may be of virtually any shape—planar, curved, and irregularly-shaped bodies are all suitable, as the nanotape or nanocarpet films suitably conform to the body's surface profile.

As described elsewhere herein, the nanostructures of the film may be characterized as being at least partially embedded within the surface in the composite article. The nanostructures may also be characterized as interacting with the surface by way of Van der Waals forces or other surface forces. Van der Waals forces may also, in some embodiments, act to affix nanostructures to each other or to stabilize the structure of the nanotape.

The composite article suitably exhibits at least one of improved thermal conductivity, an improved mechanical strength, an improved mechanical toughness, an improved damping, a reduced coefficient of thermal expansion, an improved shielding of electromagnetic interference, relative to an essentially identical composite article lacking the film of nanostructures, under essentially identical conditions.

Also provided are methods of fabricating nanostructured films. These methods include growing nanostructures having major axes on a support substrate so as to give rise to a population of nanostructures; removing from the support substrate a film comprising at least some of the nanostructures; and aligning at least some of the nanostructures of the film such that the major axes of the aligned nanostructures are substantially parallel to the plane of the film.

Suitable nanostructures are described elsewhere herein. Carbon nanotubes are considered especially suitable, although nanosheets and nanofibers are also suitable. The

Support substrates are most suitably silicon or silicon oxide. Silicon oxide is considered an especially suitable substrate for the disclosed applications.

Removal of the film from the support substrate may be accomplished chemically, mechanically, or both. Chemical removal may be performed by application of hydrofluoric acid or other agents, as described herein. Mechanical removal may be effected by peeling, prying, or shaving the film from the support. In some embodiments, part or all of the support may be dissolved or etched away so as to leave the nanostructured film behind.

Nanostructures are suitably grown on the substrate by way of catalytic growth. Catalytic growth may be accomplished by disposing a catalyst material atop the substrate and then introducing a precursor (or starting) material under process conditions such that the precursor material is converted to the desired nanostructures. In some embodiments, the catalyst and precursor materials are introduced essentially simultaneously. The use of catalytic growth techniques is considered especially suitable where the user desires to grow carbon nanotubes atop a substrate, as described elsewhere herein.

The methods may also include the step of comprising removing catalyst from the film, from the substrate, or both. This may be accomplished by washing the film, sonicating the film, or even by application of an etchant (e.g., HCl or other agent) to remove the catalyst. The catalyst may also be physically removed, by scraping, shaking, vibrating, and the like.

Alignment of the nanostructures is suitably accomplished by application of mechanical force. This force may be applied by a press, a roller, or any combination thereof. A protective sheet—such as Teflon™ or other material—may be disposed adjacent to a surface of the film during application of the mechanical force. The amount of force needed to achieve the desired alignment (as well as the proper spacing of the rollers) is determined by the user of ordinary skill.

In the non-limiting embodiments described herein, forces in the range of hundreds of kilonewtons (kN) were used to re-align vertically-oriented carbon nanotubes to the desired, more horizontal configuration. Depending on, inter alia, the size and type of the nanostructures, the user may adjust the force and duration of force application to arrive at the desired nanostructure alignment in the finished film product.

Also disclosed are reinforcement materials. These materials suitably include a film of nanostructures having major axes, with the major axes being aligned essentially parallel to the plane of the film. Such reinforcements may be termed nanotapes or nanocarpets.

Films suitably define a thickness in the range of from about 1 micrometer to about 200 micrometers or even about 500 micrometers. Intermediate thicknesses (e.g., about 20 to about 100 micrometers, about 50 to about 70 micrometers, or even about 60 micrometers) are all considered suitable. Film thicknesses in the range of nanometers, tens of nanometers, or even hundreds of nanometers are also considered suitable.

The nanostructures may include nanotubes, nanosheets, nanofibers, and the like. The film may include a monodisperse population of nanostructures, or any combination thereof. The film may, in some embodiments, be at least partially surmounted by a protective layer, which layer may be removable. Teflon™ or other filmed materials (e.g., polyethylene, polypropylene) are considered especially suitable for use in the protective layer.

The reinforcement materials may also include a glue, adhesive, elastomer, or stabilizer. Such additional material may stabilize the film; the additional material may also assist in bonding the film to a surface to which the film is applied.

Also provided are diffusion membranes. Such membranes may be used in fuel cells. These membranes suitably include a support film—suitably permeable or porous—that is at least partially surmounted by a film of nanostructures. Carbon fibers or carbon paper are considered especially suitable materials for use as the support film, although other porous or permeable materials are also suitable. Carbon fiber paper coated with Teflon™ is considered especially suitable for the disclosed membranes. Other permeable porous or fibrous materials, such as carbon cloth, are also useful.

A variety of nanostructures may be used in the disclosed membranes, including nanotubes, nanosheets, nanofibers, and the like. Carbon nanotubes (single or multiwall) are suitable for the disclosed diffusion membranes.

Nanostructures may be oriented essentially perpendicular to the plane of the film. In some embodiments, the nanostructures include major axes (e.g., such as the length of a nanotubes), which major axes are oriented essentially perpendicular to the plane of the film. The nanostructure film suitably defines a thickness in the range of from about 1 micrometer to about 200 micrometers or even to about 500 micrometers. Thicknesses in the range of tens of micrometers are considered especially suitable.

Perpendicular (also termed “vertical”) alignment of the nanostructures relative to the plane of the support film is not required. The nanostructures may be inclined relative to the perpendicular from the support film. For example, the nanostructures may be perpendicular (i.e., 90 degrees) relative to the plane of the film. The nanostructures may be 99-90 degrees, 89-80 degrees, 79-70 degrees, or even further inclined from the perpendicular to the plane of the support film.

The addition of the nanostructure film suitably enhances the properties of the membrane. The disclosed membranes suitably exhibit at least one of improved operation at a given humidity level, an improved electrical conductivity, an increased peak power density, and decreased absorbance of humidity, compared to an essentially identical diffusion membrane/layer lacking the film of nanostructures, under essentially identical conditions.

Methods of fabricating diffusion layers are also provided. These methods include disposing a film of nanostructures having major axes atop a surface of a support membrane, the major axes being oriented essentially perpendicular to the plane of the support membrane/layer. Perpendicular alignment is not required; as described above, the nanostructures may be inclined from the perpendicular.

Disposing may be accomplished by placing the film of nanostructures atop the surface of the support membrane. Nanostructures may also be disposed atop the support membrane by growing the nanostructures atop the surface of the support membrane. Suitable nanostructures are described elsewhere herein; carbon nanotubes are considered especially suitable. The carbon nanotubes may be grown atop the support membrane. Growing carbon nanotubes atop a carbon paper membrane is considered especially suitable, as described in the appended Examples section.

Additionally disclosed are fuel cells. These fuel cells—which may be characterized as proton exchange membrane (“PEM”) fuel cells—include a proton exchange membrane; an anode gas diffusion layer (“GDL”) in contact with the anode catalyst layer; and an anode catalyst layer in contact with the anode gas diffusion layer and the proton exchange membrane. The cells also suitably include a cathode catalyst layer that is in contact with the proton exchange membrane and the cathode gas diffusion layer; and a cathode gas diffusion layer. In suitable embodiments, at least one of the anode gas diffusion layer and the cathode gas diffusion layer are at least partially surmounted by a film of nanostructures having major axes oriented essentially perpendicular to the plane of the anode gas diffusion layer or the cathode gas diffusion layer.

The nanostructure films suitably defines a thickness in the range of from about 1 micrometer to about 200 micrometers or even about 500 micrometers. Because of the incorporation of the films, the fuel cells suitably exhibit improved performance at relatively low humidity levels compared to an essentially identical fuel cell lacking the film of nanostructures, under essentially identical conditions.

In some applications, the disclosed nanostructure-bearing membranes may be used as the gas-diffusion layer (“GDL”) in a standard PEM fuel cell that uses a conventional membrane lacking nanostructures. In such embodiments, the GDL of the PEM cell may be replaced with a GDL according to those described herein. The user may then modulate the operating conditions of the fuel cell to optimize the cell's operation.

### Examples and Non-Limiting Embodiments

Provided below are various exemplary and non-limiting embodiments. These are illustrative only and do not in any way limit the scope of the present disclosure.

### 1.1 Nanotape Production

In one non-limiting embodiment, nanotape reinforcements are created from multi-walled carbon nanotubes (MWCNTs), although single-walled carbon nanotubes may also be used.

First, a suitable substrate (such as silicon with a thin, about 100 micrometer, silicon oxide layer) is prepared with or without a thin catalyst layer (such as iron, Fe, with a suitable thickness, about 20 micrometer) suitable for the growth of carbon nanotubes (the catalyst layer could be iron, Fe, Nickel, Ni, or Cobalt, Co).

The substrate is placed inside a Chemical Vapor Deposition (CVD) furnace and a suitable mixture of a carbon-source fluid (such as Xylene) (and a proper catalyst material, such as Ferrocene, if the substrate in step one does not have the catalyst layer, i.e., Fe, on it; one ratio is 1 gram of Ferrocene in 100 ml of Xylene)) is fed into the CVD furnace under suitable proper temperature (about 750° C.) and flow conditions to grow Vertically Aligned Carbon Nanotube Nanofilm (VA-CNT-NF) with the height of about 100-120 micrometers on the suitable substrate and let cool off to about room temperature for about 4 hrs under an inert gas, e.g., argon, helium, nitrogen, neon, and the like.

The VA-CNT-NF and substrate are removed from the CVD furnace and are optionally placed inside a plasma cleaning machine to purify the VA-CNT-NF and remove amorphous carbon. The substrate with the VA-CNT-NF is removed from the plasma cleaning machine, and the VA-CNT-NF is subsequently removed from the substrate chemically (one may also use mechanical techniques for removal), in a diluted (1%) HF acid solution for a sufficient time, e.g., less than one minute. Other removal agents are described elsewhere herein.

The VA-CNT-NFs (Vertically Aligned-Carbon Nano Tube-Nano Films) can be removed from the substrate chemically (one could also use mechanical tools for this removal) in a diluted hydrofluoric (HF) acid solution for less than one minute. Even though hydrofluoric acid (HF) has unique properties as this acid is able to dissolve most metal oxides, there are many issues regarding HF acid use that make it undesirable. For example, hydrofluoric acid can irreversibly etch glass. Most notably, there are severe health and safety issues associated with the use of hydrofluoric acid. Although it is a relatively weak acid it is nonetheless extremely dangerous, and care must be taken in handling the acid. Eco-Etch™ is a product which can replace hydrofluoric acid in cleaning, etching, de-scaling, and other applications, including removal of metal based oxides and scales as well as for cleaning silicon wafers and semiconductor substrates.

The user may also use an etching agent that contains phosphoric acid such as Ceramic Etchant A from Sigma Aldrich or Alumiprep 33 from Henkel. However, etch rates using these etching agents could be slower compared to HF acid solution.

To test the etch rate, Alumiprep was used to etch VA-CNT-NFs from silicon oxide substrate. FIG. 54 shows etched VA-CNT-NFs from the substrate before and after immersion in Alumiprep 33. VA-CNT-NF samples took 90 seconds to etch away from the substrate, whereas diluted (10%) HF acid took under 30 seconds to etch the same sample.

The VA-CNT-NF removed from the substrate is placed in an etchant, e.g., 37% HCl acid, for sufficient time (e.g., about 4 hours) such that the catalyst layer(s), i.e., Fe, attached to it will come off. The “clean-purified” VA-CNT-NF may then be placed between two Teflon films, one on top and one on bottom, and this assembly is then placed between two aluminum plates, one on top and one on bottom.

This combined assembly is passed through a rolling machine that applies sufficient pressure to this assembly to fully align the VA-CNT-NF form the vertical direction into the horizontal direction to produce nanotape with a thickness of 40-70 micrometers (i.e., equal to the distance between adjacent plies fibers filled with only matrix in composite materials). The process may be used to fabricate nanotapes having thicknesses other than 40-70 micrometers, and the user of ordinary skill in the art will encounter no difficulty in modulating the process conditions to give rise to a film of the desired thickness.

In one embodiment, 2-propanol, when sprayed onto a CNT wafer and rolled in a particular direction, aligns the CNTs horizontally in that direction. Other alcohols or fluids may be used to enhance processing and alignment of nanostructures. Once the nanostructures are aligned, the aligned material and the supporting substrate may be dried, e.g., in an incubator or oven.

MWCNT-nanotapes may be transferred from the wafer onto the prepreg by direct “printing” of wafers onto the prepreg using a hand-nominal pressure on the wafer. This technique is particularly suitable for wafers where the MWCNTs are grown by a gas injection process.

In a gas injection, the wafers are normally made of Si/SiO₂ on which a thin layer of Fe or other catalyst is deposited, e.g., using a target system in a sputtering machine. This wafer is then placed in a CVD furnace and a carbon source is injected into the CVD furnace to grow MWCNTs.

A liquid injection technique may use a Si/SiO₂ wafer and places this wafer into a CVD furnace and uses about 0.1 wt % of ferrocene (i.e., Fe source) plus 10 ml of xylene (i.e., carbon source) mixed as a liquid, passed through a heater, and then injected into the CV furnace, where Fe is deposited onto the wafer and MWCNTs grow at the locations of the Fe particles.

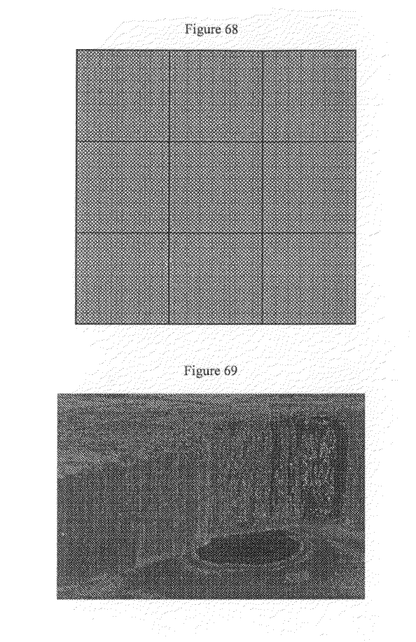

FIGS. 65-68 show transfer of nanotape from wafers onto prepreg for gas injection, although this may be used also for the liquid injection technique. The diamond patterns that appear on the transferred nanotapes on the prepregs, in FIGS. 65-68 are the prints on the prepreg from separating Teflon™ films that are accentuated on the transferred nanotapes. Also, FIG. 68 shows a schematic of many square wafers transferred onto a prepreg side-by-side employing an automated system to cover the entire surface of the prepreg with MWCNT-based Nanocarpet-nanotapes. The edges are left without the nanotapes for trimming after curing.

The process is suitably performed by removing the VA-CNT-NF from the substrate first, making an assembly as mentioned above and passing the assembly through double rollers to produce a nanotape with CNTs aligned horizontally. Aluminum or other metal plates are suitable for the rolling process. Aluminum is more compliant than steel plates, and produces desirable results without damaging the nanostructures.

The nanotubes of the tape are suitably in a horizontal conformation (effected by forming the right assembly or rolling and providing sufficient pressure). The thickness of the nanotape is suitably the distance in between the fibers of two adjacent layers in composites, e.g., about 40-70 micrometers.

To use the manufactured nanotapes, one film (e.g., one of the Teflon™ films) is removed, the nanotape placed on a surface of interest, and the second film layer is removed. A second surface may be applied to the now-exposed face of the nanotape. The surface on which the nanotape is applied may have some inherent tackiness, as the surface may be a wet lay-up, resin, adhesive, or a thermosetting prepreg. For a thermoplastic prepreg, the nanotape can be peeled from the second film by application of a sharp blade or scraper.

### 1.2 Mass Production of Nanotapes

Nanotapes may also be fabricated in a mass-production approach. To perform mass-production of nanotape (e.g., in linear yards, such as on a roll with the width of 3 yards), individual nanotapes with a certain area (e.g., “R” square inches, based on the size of the substrate and the diameter of the CVD furnace tube) can be mass-produced at the same time.

This may be effected by (1) horizontal distribution, i.e., by having many tubes (e.g., “S” number of tubes) and multiple wafers within each tube (“M” number of substrate/wafers per tube) of the CVD, and (2) vertical stacking, i.e., growing VA-CNT-NF on top of each other on a single substrate by alternating supply of carbon-source (e.g., xylene) and catalyst (e.g., ferrocene) solution under conditions to grow 100-120 micrometers (about 30 minutes) of VA-CNT-NF and then turning the furnace off but passing only inert gas, Ar, for a time, e.g., 30 minutes.

The user may then repeat the process by alternating these gas flows and their corresponding temperature and flow conditions. Each cycle (e.g., 60 minutes) will produce one layer of VA-CNT-NF (e.g., 100-120 micrometers). The number of cycles of N*60 minutes will then produce a stack of N VA-CNT-NFs. The foregoing conditions are illustrative only, and the user of ordinary skill will be able to effect nanotape production under the conditions necessary to produce nanotapes of the desired configuration.

The total stack can have a height on the order of tens of micrometers, of hundreds of micrometers, or even of millimeters. When the desired N is achieved, the furnace is turned off and an inert gas (e.g., argon) may be flowed over the stack to give rise to room temperature (for about 4 hrs).

Stacks of horizontally distributed VA-CNT-NFs on their substrate are taken out of the furnace, are plasma cleaned, and then the whole stack is removed from the substrate using 1% HF or other etchant for less than a minute. In this way, the stack of N VA-CNT-NFs are separated from the substrate but remain attached to each other.

The N VA-CNT-NFs are suitably be separated from each other during the etchant (e.g., 37% HCl acid) treatment. Four hours is a suitable time of treatment, although shorter treatments are also useful In this way, the product area produced from a single run of a CVD furnace will be R*S*M*N square inches.

Next, these individual VA-CNT-NFs (i.e., S*M*N VA-CNT-NFs) can be arranged, with overlaps at adjacent edges of VA-CNT-NFs on a film (e.g., Teflon™) assembly to produce a continuous nanotape (without gaps). The product may be 3 yards in width and of virtually any desired length; the ultimate length and width of the final product will depend on the needs of the user.

Nanotape-film assemblies are suitably placed between aluminum or other plates to provide an assembly that is passed through a high-pressure rolling machine to produce a continuous nanotape in linear yards, as shown in FIGS. 8 and 57. This nanotape is already inside Teflon-films which can then be rolled over a mandrel and be presented as rolls similar to traditional composite tapes and/or prepregs.

The rolling machine used for the horizontal alignment of the VA-CNT-NFs was a Stanat TA-3 15 2-hi/4-hi combination back up driven torque arm rolling mill with a 10 hp and four speed gear shift drive that can produce rolling speeds of approximately 35, 70, 105, and 140 FPM. In the 2-hi mode, the rolls have a diameter of 5 in with 8 in face width. The rolling mill was set in the 2-hi configuration at the lowest speed for the alignment of the VA-CNTNFs. The rolling machine has a force dynamometer that was connected to an oscilloscope. The voltage shown on the oscilloscope was used to find the rolling force. The oscilloscope was set at 5 mV/div with 1 mV equal to 10,000 lbs.

During rolling, the mill experiences deformation along with the work piece. The work piece undergoes plastic deformation (in this case, VA-CNT-NFs undergoes an orientation transformation, i.e., from vertically aligned to horizontally aligned) while the rolls and rolling mill undergo some elastic deformation. This machine deformation is elastic and behaves as a spring which is why this phenomenon is known as mill spring. The deformation due to mill spring results in a final height which is larger than the roll opening. By recording how this height difference changes according to roll force, the effect of mill deformation can be minimized. The change in height can be measured with calipers and the roll force can be read off the oscilloscope attached to the mill. The modulus of the mill can be calculated using the spring equation and was calibrated to be 404 1.8 kip/in in the non-limiting embodiment described here.

FIG. 55 shows an exemplary elastic curve for mill spring and plastic curve for rolled material with initial thickness h1 and rolled thickness h2 with initial roll gap S₀. Using the average mill modulus of the mill, it is found that 360 KN of force is required to horizontally align the VA-CNT-NFs sandwiched in between the aluminum plates.

To achieve continuous production, aluminum sheets are used as replacement for aluminum plates. In the following step, purified VA-CNT-NFs are slightly overlapped at their edges and placed in between Teflon™ films.

Next, the VA-CNT-NFs/Teflon™ films/high strength aluminum sheets are assembled together and the entire assembly is rolled through the rolling machine. A continuous process (e.g., FIG. 8 and FIG. 57) can be achieved using this methodology.

Aluminum plates for the rolling of the VA-CNT-NFs to convert them to nanotapes may be replaced by rolling sheets of tough flexible materials such as steel, aluminum, or other suitable material. Sheets having a thickness in the range of about 0.010-0.040″ are flexible enough to be wrapped over a storage or take-up spool; aluminum sheets are used here for illustrative purposes.

A flexible rolling sheet made of aluminum having a thickness of about 0.013″ was used, although sheets of other thicknesses and materials may also be suitable. The rolling sheets sandwich the VA-CNT-NFs sandwiched between the Teflon™ Films. Such a system is suitable for the continuous rolling and production of nanotape material, especially when long nanotapes are needed and are to be wrapped over take-up spools for storage and shipping purposes.

### 1.3 Growth of Nanostructure Films

There are a number of techniques for growing VA-CNT-NFs, including chemical vapor deposition (CVD), arc-discharge, and laser ablation; the non-limiting examples herein employ a CVD technique. While the use of carbon nanotubes is explored in these examples, the methods and materials disclosed herein should not be understood as being limited to carbon nanotubes.

Within the CVD process, a substrate such as silicon coated with a thin layer of silicon oxide (e.g., about 100 micrometers) is used. To grow VA-CNT-NFs, a catalyst layer is used on the substrate so that carbon atoms can be placed on the catalyst to form the carbon nanotubes.

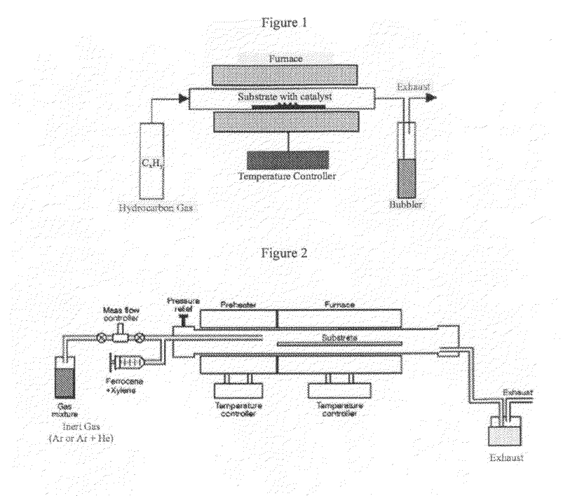

Catalyst may be placed on the substrate in a variety of ways. One way involves direct sputtering of iron, Fe (or nickel, Ni, or cobalt, Co) on the substrate (a thin coating of about 20 micrometers) and then placing this catalyst coated substrate in the CVD furnace. The user then supplies a carbon source into the CVD module to grow the carbon nanotube using proper temperature and flow conditions (e.g., FIG. 1). As shown in that figure, a precursor gas (e.g., a hydrocarbon gas) is introduced to the reactor, where a catalyst-bearing substrate is positioned. The conditions in the reactor are modulated such that nanostructures (e.g., carbon nanotubes) are grown on the substrate. Exhaust from the reactor may be fed through a bubbler or other device to capture any desired materials, as shown in the figure.

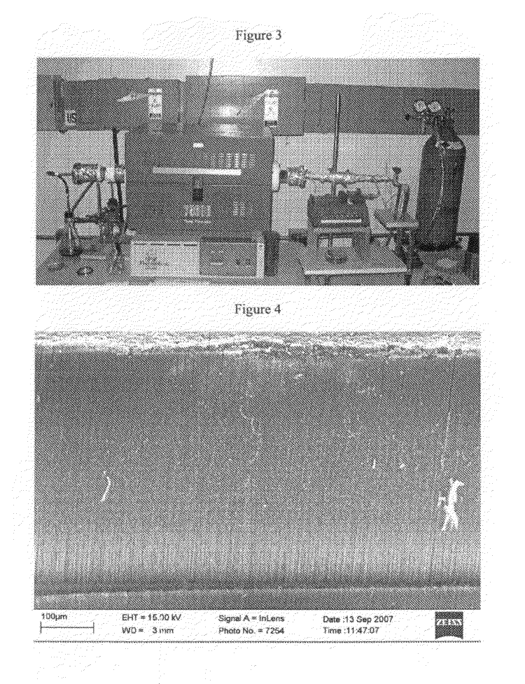

In an alternate techniques, the substrate (e.g., silicon with a silicon oxide layer) is placed in the CVD furnace and then supplied with a carbon source (e.g., xylene, 100 ml) and catalyst material (e.g., ferrocene, 1 gram) in the CVD module to grow the carbon nanotube using proper temperature and flow conditions (see FIGS. 2 and 3).

With reference to FIG. 2, an alternative nanostructure synthesis system is shown. As depicted, an inert gas along with ferrocene (a catalyst) and xylene (a carbon source) are fed to the reactor, within which a substrate is disposed. Mass flow, pressure, and temperature controls may be modulated such that the proper conditions are achieved for nanostructure (e.g., carbon nanotube, carbon nanoparticles, carbon nanofiber) growth. Exhaust may be passed through a bubbler or other process unit so as to reduce release of any particular materials or chemical species. FIG. 3 is a photograph of such an experimental setup, with a tube furnace serving as the location where the substrate is placed.

Once VA-CNT-NFs are grown to the desired length, the furnace is turned off and an inert gas (e.g., argon) is flown through the furnace till the furnace is cooled down to about room temperature, before the VA-CNT-NFs on the substrate can be removed from the furnace.

FIG. 4 shows an SEM of one of an exemplary VA-CNT-NFs, illustrating the capability of growing well-aligned MWCNTs in the millimeter range in a CVD furnace.

FIG. 5 shows a TEM image of single MWCNTs manufactured in CVD furnaces to illustrate the capability of producing various types of MWCNTs with various diameters.

### 1.4 Purification of VA-CNT-NFs

Because VA-CNT-NF may contain impurities from the synthesis process such as catalyst particles and amorphous carbon, plasma etching and high temperature annealing (for a few minutes) are used to remove the amorphous carbon from the VA-CNT-NFs.

In one approach to removing the VA-CNT-NFs from the substrate, the material is immersed in 1% HF acid for less than a minute. To remove the catalyst from the VA-CNT-NFs, a simple acid treatment method is used. The VA-CNT-NFs free of amorphous carbon are immersed in 37% hydrochloric (HCl) acid solution at room temperature for an hour, followed by rinsing with deionized water.

After one or more (e.g., 3, 4, or 5) cycles of treatment, the VA-CNT-NFs are rinsed gently with distilled water several times and dried in a vacuum furnace for 1 hour. The samples at each step were analyzed using SEM and Energy Dispersive X-ray Spectroscopy (EDS) to ensure that the thin Fe catalyst layer was removed to establish the process and time needed to fully remove the catalyst layers.

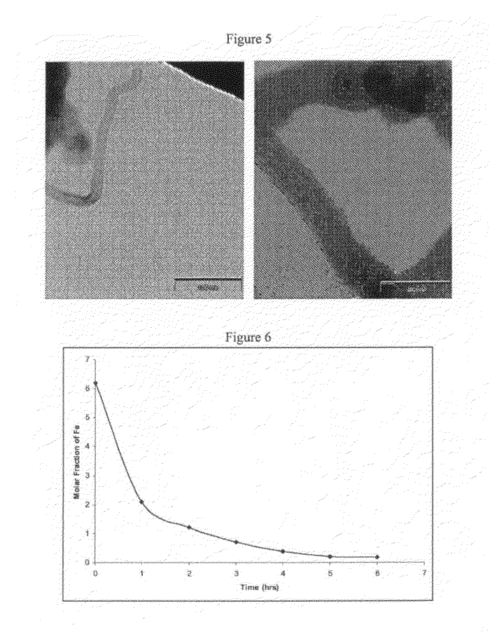

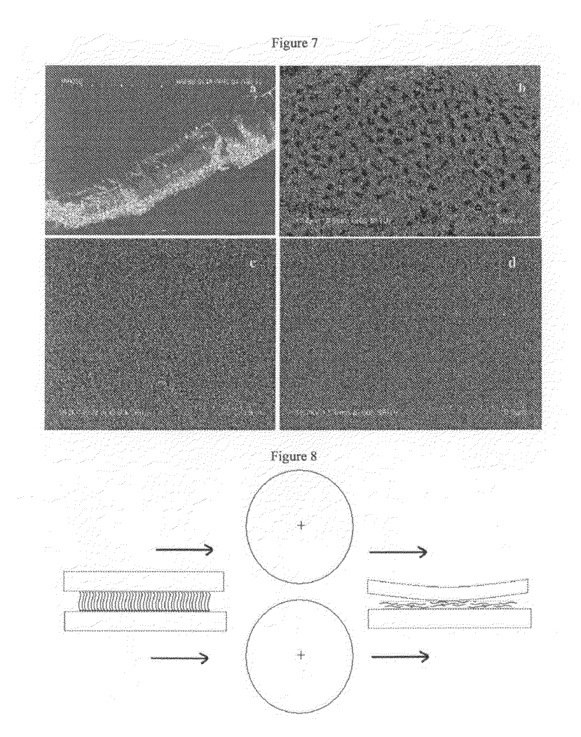

FIG. 6 depicts the molar fraction of Fe catalyst in the as-prepared samples as a function of the total reacting time in HCl solution. FIG. 7 depicts SEM images of the acid treated VA-CNT-NFs after 4 hours of treatment. FIGS. 7a, 7b, and 7c depict the bottom surface of the VA-CNT-NFs with the thin Fe catalyst layer removed, and FIG. 7d illustrates a top surface which is free from any impurities such as catalyst layer and amorphous carbon. Reaction time with the acid solution is one useful parameter for effecting optimal removal of catalyst particles from the VA-CNT-NFs without disturbing their structures.

1.5 Development of Nanotapes from Purified VA-CNT-NFs

Current methods of manufacturing nanotubes, such as chemical vapor deposition and spin-casting both lack the precision required to produce consistent sizes, shapes, orientations, placement, and densities. The density and volume fraction of aligned CNTs achieved through this process is very low due to the very low dispersive ability of CNTs in solutions. Hence, the potential of CNTs has not fully been explored due to the lack of bulk alignment techniques in horizontal direction.

To circumvent the challenge of effecting bulk nanotubes alignment in the horizontal direction, a novel technique is depicted in FIG. 8. In that technique, purified VA-CNT-NFs are sandwiched between, first, a pair of Teflon films, and then, a pair of aluminum plates (e.g., about ¼ to ½ inches in thickness each), and finally press-rolled through high pressure rollers to produce nanotapes.

Initially, the purified VA-CNT-NFs were sandwiched in between Teflon films, and then sandwiched in between aluminum plates of slightly larger area. The thickness of the aluminum plates were ¼ or ½ inches and the thickness of the purified VA-CNT-NFs were about 120 μm (i.e., about the length of the CNTs). Steel plates may also be used; the user may use a suitable pressure so as not to damage the nanotape product.

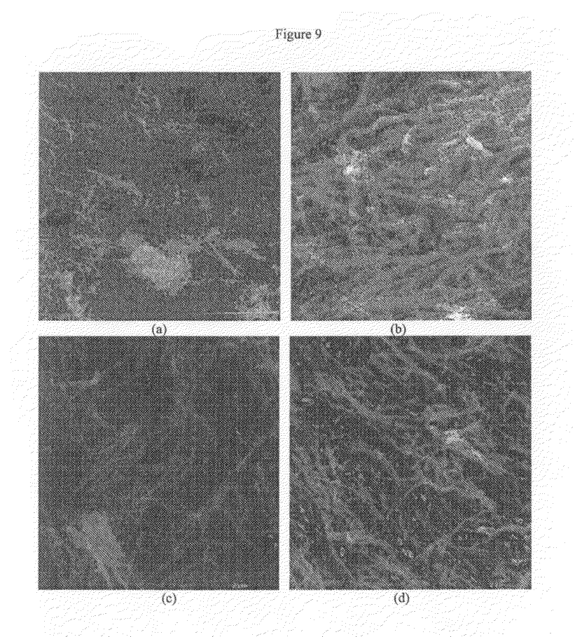

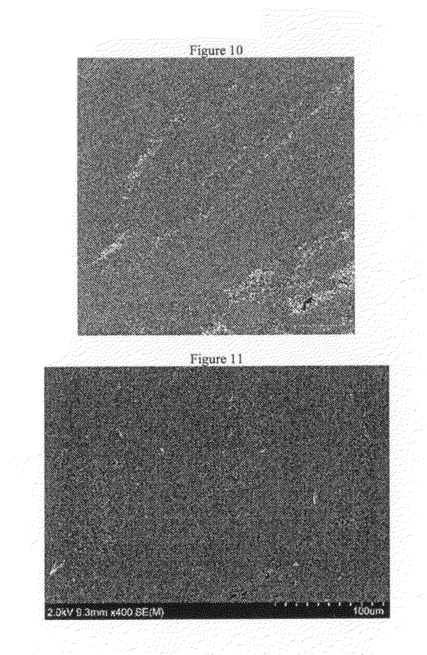

FIG. 9 depicts typical SEM images of carbon nanotube alignment through various stages of press-rolling technique at high magnification. FIGS. 10 and 11 show lower magnification of FIG. 9d and reveal the bulk alignment of CNTs in the horizontal direction.

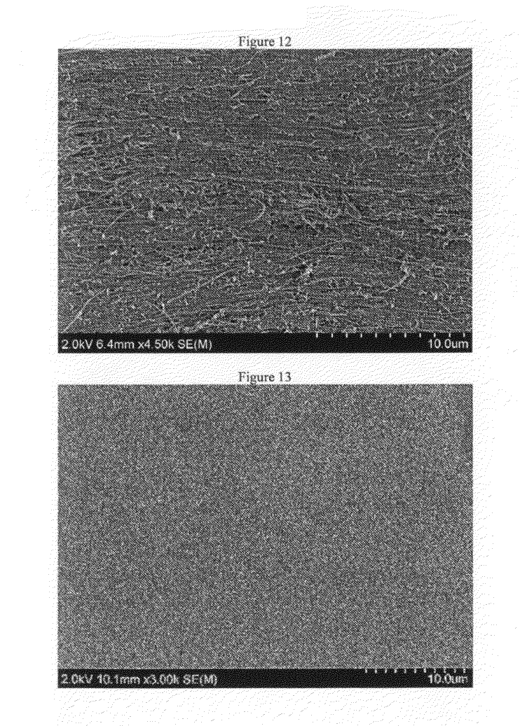

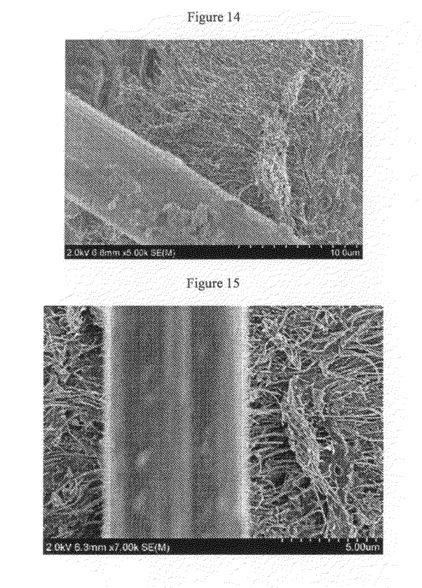

FIG. 12 shows SEM image of fractured composite sample with nanotape embedded with alignment in horizontal direction. FIG. 13 shows a cross section of horizontally well-aligned nanotape inside a composite. FIGS. 14 and 15 show fractured composite samples with embedded nanotape, demonstrating good alignment of the nanotape in the in-plane and in the fiber longitudinal (FIG. 13) and transverse (FIG. 14) directions.

### 1.6 Mass-Production of Continuous Nanotapes

The procedure for the mass-production of nanotapes has been previously described. As explained, it is possible to have many tubes within each CVD furnace, and it is possible to have many substrate wafers in each tube. For convenience, these configurations are called Horizontal Distribution. It is also possible to have multi-layers of VA-CNT-NFs on top of each substrate/wafer by altering the feed (e.g., xylene and ferrocene) and inert (e.g., argon) gases as well as the condition of the furnace alternatively (e.g., every 30 minutes) to grow multiple layers of VA-CNT-NFs on top of each other.

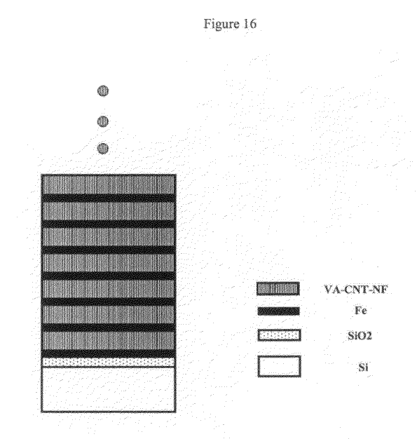

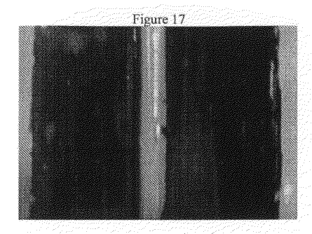

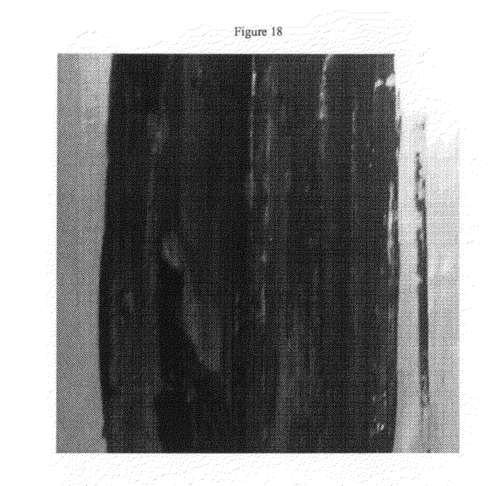

After the desired number of layers is grown, one may turn off the furnace and let the inert gas run (e.g., for about 4 hrs) to reduce the temperature to room temperature. This configuration is termed vertical stacking and is shown schematically for a single substrate in FIG. 16. As depicted in that figure, a silicon substrate is surmounted by a layer of SiO₂. Alternating layers of Fe catalyst and vertically-aligned carbon nanotubes are then disposed atop the substrate. Separation of the stack of nanotubes layers from the wafer and then the separation of individual VA-CNT-NFs (films) was previously explained.

Individual pieces produced in a mass-production routine can be “stitched” together to produce a continuous wide and long role of nanotape. FIG. 17 shows two typical, separate pieces of purified VA-CNT-NFs being stitched together to make a continuous roll. FIG. 18 shows two pieces of purified VA-CNT-NFs, slightly overlapped at the edges, placed in between Teflon™ films, and placed on one bottom aluminum plate.

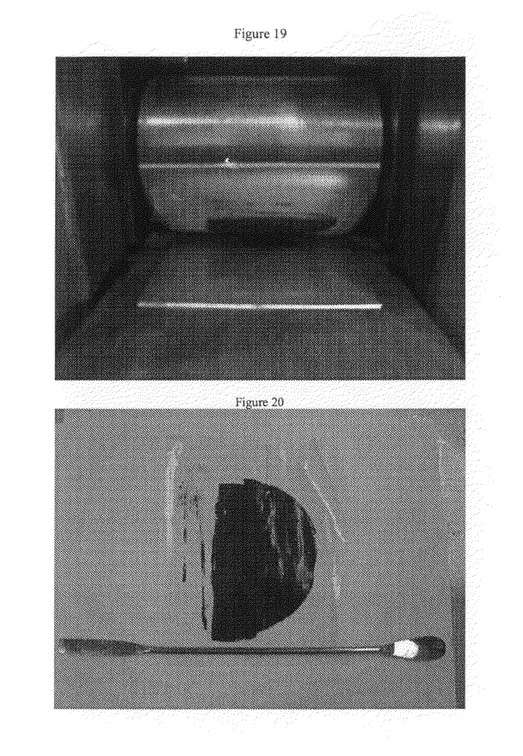

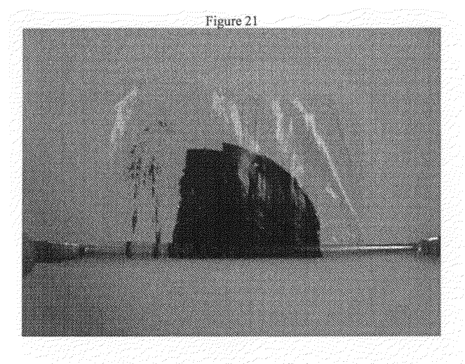

Next, the top side of the aluminum plate is contacted to the assembly of FIG. 18, and the entire assembly is rolled through a rolling machine as shown in FIG. 19. FIG. 20 shows a continuous nanotape made of a number of typical pieces of purified VA-CNT-NFs, inside the Teflon™ films.

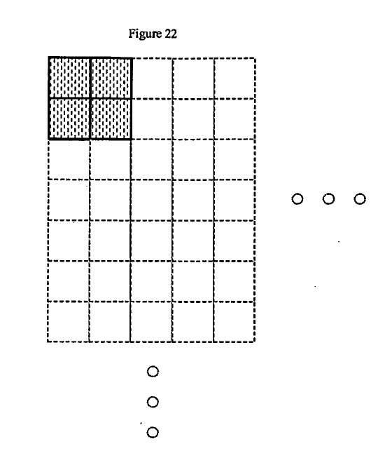

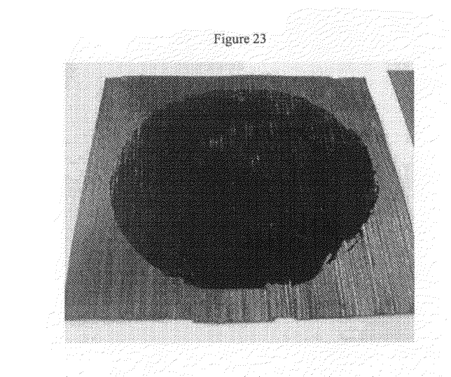

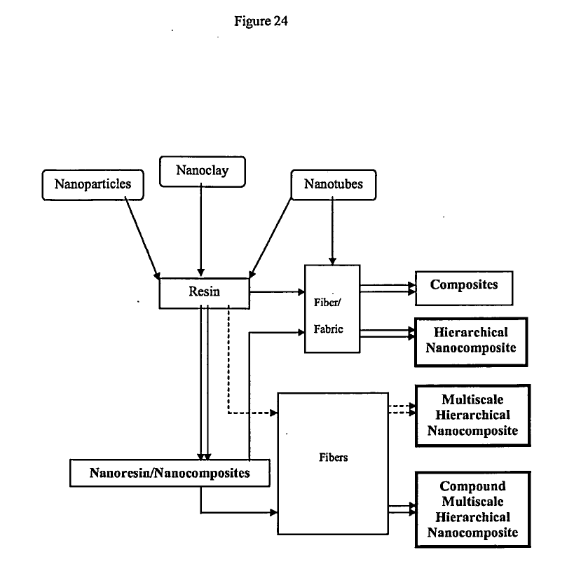

FIG. 21 shows the continuous nanotape of FIG. 20, inside Teflon™ films, as a typical continuous nanotape, rolled over a spool, when is mass-produced and stored on spools for bulk shipments. FIG. 22 shows how a stitching (e.g., 4-piece) can be extended to a larger number of pieces to produce large quantity of nanotapes placed in between Teflon™ films and rolled over spools for bulk shipment. FIG. 23 illustrates placement of nanotape on a composite lay up (e.g., a wet lay-up or a prepreg).

FIG. 57 depicts an exemplary embodiment of a mass-production method for nanotapes. As illustrated in the figure, a population of vertically-orientated nanostructures (in this case, carbon nanotubes) are disposed atop a first Teflon™ film. A second Teflon film is disposed atop the nanotubes, and the film-nanotube assembly is then contacted above and below by rolling sheets of aluminum. The assembly is then fed between the rollers, which in turn apply pressure to the nanostructure film so as to horizontally align the nanostructures to form a nanotape. The nanotape is then taken up on a collection spool; the aluminum pressing/rolling sheets are likewise taken up on their own take-up spools. The process may be performed in a batch or a continuous mode.

The roller-based approached described above does not limit the scope of the present disclosure. Other processes—such as applying a shear or tangential force to nanostructures—to effect horizontally-aligned nanostructures are also suitable.

### 2.1 Manufacturing and Characterization of Hierarchical Multifunctional Nanocomposites Employing Nanocarpet-Nanotapes

Development of hierarchical nanocomposites is summarized in FIG. 24. Development of nanocomposites usually involves a fiber structure reinforced by in-situ growth of carbon nanotubes (CNTs) on the surface. In this current invention, horizontally aligned multi-walled carbon nanotube (MWCNT) nanotapes are used as structural reinforcements in composites, adhesives, resins, and panels with cut-out holes (for mechanical fasteners). Mechanical characterizations of the samples are performed using short beam shear, tensile, and double cantilevered beams (DCB) test samples. The properties of such nanocomposites are discussed below.

Mechanical characterizations of the samples have been performed using Double Cantilevered Beam (DCB) loading in longitudinal direction according to the ASTM D 5528-01 test standard to measure the Mode I opening fracture toughness. Short Beam Shear test (ASTM D 2344) is used to measure short beam shear strength; and tensile tests ASTM D 3039 are used to measure sample stiffness, strain-to-failure, and tensile strength.

### 2.1.1 Manufacturing and Testing of DCB Samples Using Nanocarpet-Nanotapes

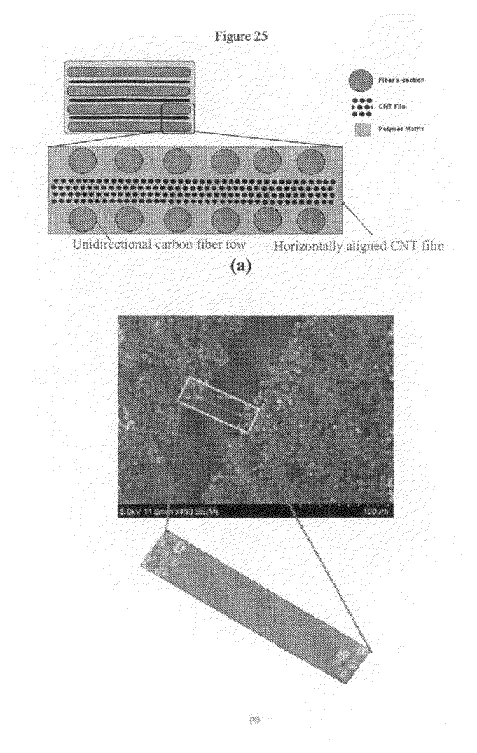

FIG. 25(a) shows a schematic of exemplary, disclosed hierarchical composites, wherein nanotapes are used in between composite layers to fill the gap between the fibers of adjacent layers for the entire composites. As depicted in the figure, a nanostructure film (“CNF film”) is disposed between fibers. For purposes of this figure only, the major axes of the nanostructures are essentially parallel to the direction of the fibers' axes. This orientation, however, is not a requirement, and the axes of the nanostructures may be aligned perpendicular to the fibers or even at an angle to the fibers' axes.

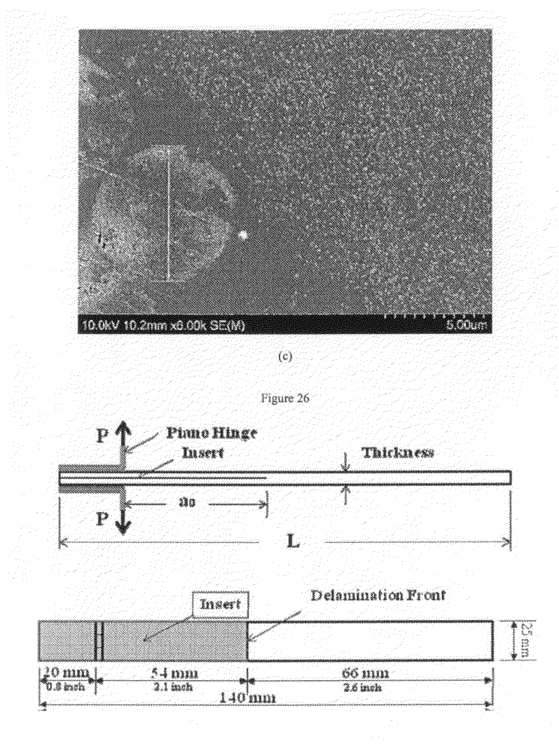

FIG. 25(b) shows the interlaminar distance between two plies of a base composite without nanotape, where the inset shows a nanocomposite where the interlaminar distance is filled with a nanotape. FIG. 25(c) shows the dimension of a single carbon fiber as compared with well aligned horizontal carbon nanotubes within the nanotape. FIG. 26 shows the schematic of the side and top views of the DCB specimen according to ASTM D 5528-01.

### 2.1.1.1 Manufacturing and Testing of the DCB Composite Samples Using Nanocarpet-Nanotapes and a Wet Lay-Up Technique

For manufacturing DCB samples, 8 layers of 15.9 ft/lb unidirectional carbon fiber tows were used to manufacture the carbon/epoxy base composite. Epoxy resin obtained from Fiberglass Hawaii was used for wetting the fibers.

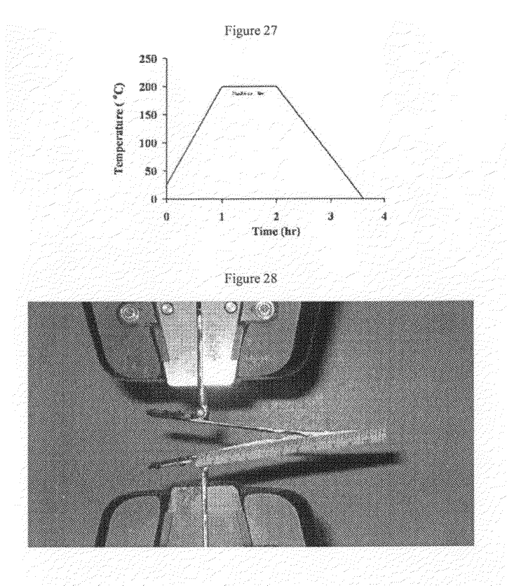

A hand lay-up technique was employed to manufacture the composites in an aluminum 6061 mold. The samples were then put inside the a compression molding machine under a uniform pressure of 12,000 psi and heated from room temperature to 200° C. in 1 hour, and held at that temperature for one more hour before cooling it down to the room temperature. The uniform pressure allows to dramatically reduce the voids and air pockets that are present within the layers that are laid-up adversely affecting the strength and performance of the specimen, if not extracted. FIG. 27 depicts the cure cycle employed to cure the composite specimens inside the Hot Press. DCB samples with and without nanotapes were manufactured.

DCB test provides the Mode I Interlaminar Fracture Toughness, G_{IC}, of the continuous fiber-reinforced composite materials using the base composite (i.e., pristine composite) and novel nanotape-reinforced hierarchical nanocomposite.

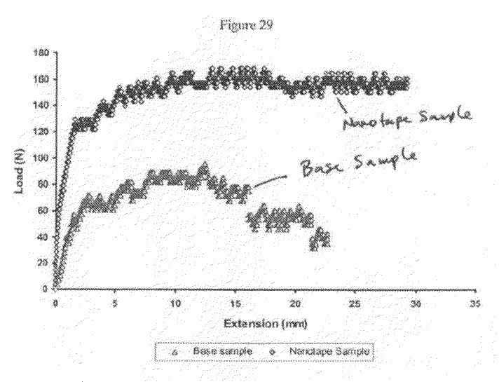

FIG. 26 shows a schematic of a DCB specimen geometry as described by the ASTM standards employing piano hinges. In a DCB sample, an artificial delamination crack is produced within the mid-plane during its manufacturing using a Kapton™ sheet about 13 micrometers in thickness. In Mode I fracture, the delamination faces open away from each other either due to the applied load, P, through attached hinges or the constant cross head movement of the machine (see FIG. 28). All the specimens were 140 mm (5.5 in) long, 25 mm (1.0 in) wide, and about 3.0 mm (0.12 in) thick.

The insert length is about 74.0 mm (2.9 in) long. This distance is long enough to provide an initial delamination length of approximately 54.0 mm (2.1 in) as measured from the loading point plus extra length of approximately 20 mm (0.8 in) to bond the piano hinges, as shown in FIG. 26.

For all specimens subjected to the DCB tests, the artificial delamination end was opened by controlling the machine crosshead movement. The load, crosshead displacement, and delamination lengths were recorded.

Modified Beam Theory (MBT) was selected to calculate Mode I Interlaminar Fracture Toughness as comparison to the other two methods, i.e., Compliance Calibration (CC) and Modified Compliance Calibration (MCC) methods. It has been reported that the MBT method yields the most conservative values of G_{IC}.

Delamination growth was measured manually using a high magnification microscope equipped with light source as explained by the ASTM code. Load versus opening displacement was recorded digitally for post-processing. An optical microscope equipped with a light source was positioned at the delamination front. Delamination length as designated by symbol “a” was recorded manually as crack opened along the edge of debond as the opening displacement increased. nanotapes were placed in between alternating carbon fiber tows as depicted in FIG. 25(a).

As explained earlier, load versus opening displacement was recorded digitally for the purpose of post-processing for all the DCB specimens tested. FIG. 29 shows an exemplary load versus opening displacement for the base sample and the CNT nanotape sample. The displacement rate for all the samples tested was set at about 1 mm/Min. FIG. 29 shows that load increases almost linearly and monotonically, approaching a maximum value of about 70 N for the base specimen. At this point, load remained almost constant with slight fluctuation as the corresponding opening displacements were increased sharply.

At larger extensions, load decreased monotonically due to crack propagation. For the nanocomposite specimen with nanotape, the initial load monotonically increased to a linear value of about 130 N. However, unlike the base sample, the load extension curve showed an increase in load initially which remained constant with further increase in extension. No decrease in load was observed at larger extension. At each step during loading, delamination growth length with respect to the point of loading was measured manually through high magnification microscope. The nanotape nanocomposite exhibited a similar modulus increase in fracture as compared to Short Beam Shear test samples tested for interlaminar shear strength.

The two initial values of G_{IC} associated with the initial delamination growth are of interest, which are calculated from the load and its corresponding opening displacement. The first G_{IC} is associated with the point where load versus opening displacement deviates from linearity (i.e., NL point). For example in FIG. 29, the NL point associated with the load and the corresponding opening displacement for the base sample is selected at 65 N and 3.5 mm, respectively. The second G_{IC} is associated with the point where delamination initiation is visually observed (i.e., VIS point). For example, in FIG. 29 the VIS point associated with the load and the corresponding opening displacement is selected at 65 N and 3 mm, respectively. For exemplary DCB specimens, the delamination growth was slow and stable. Modified Beam Theory method was employed to calculate G_{IC} for the NL and VIS points and also for other remaining points that required a load versus opening displacement curve.

To study nanotape inclusion on the performance of the resulting nanocomposite, pristine composite and nanotape nanocomposite using unidirectional carbon fibers were manufactured by the wet lay-up technique. Unidirectional composites specimens were used to perform DCB tests in order to calculate Mode I Interlaminar Fracture Toughness, G_{IC}, in the longitudinal direction employing the ASTM D 5528-01 standard.

DCB specimens were manufactured with specific dimensions as provided by the ASTM code as shown in FIG. 26. G_{IC} points are associated with the subsequent delamination growth as measured manually with increasing displacement. Modified Beam Theory Method was selected because this method yields the most conservative values for the G_{IC} values with respect to the other methods. The beam expression for the strain energy release rate of a double cantilevered beam is defined as follows and as reported in the ASTM standard.

G_{I}=3*P*d/2*b*a (1)

where

### P=Load,

d=Load point displacement,
b=Specimen width, and
a=Delamination length

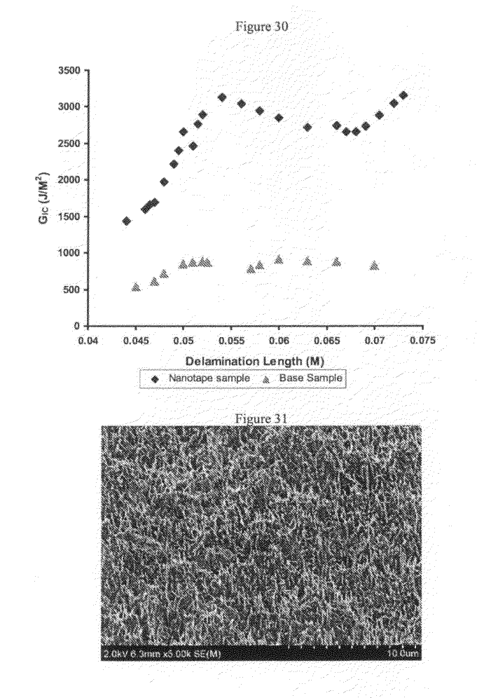

In some cases, the above G formula may overestimate G_{I}, since the beam is not fully built-in at the free end, and rotation may occur at the delamination front. In order to compensate for this rotation, one may assume that the DCB specimen contains a slightly longer delamination, i.e., a+|Δ|. In such case |Δ| is calculated experimentally by plotting the least square line into the cube root of compliance, C^{1/3}, as a function of delamination length “a”. Compliance, C, is defined as the ratio of load point displacement to the applied load, i.e., d/P. FIG. 30 shows the Delamination Resistance Curve (i.e., R Curve) for a typical base composite and nanotape nanocomposite. The delamination resistance curve defines G_{IC} values as a function of the delamination length. As explained earlier, the first G_{IC} value on the R curve is associated with NL point while the second G_{IC} value is associated with VIS point.

FIG. 30 gives the comparison between the typical delamination resistance curve (i.e., R Curve) for the pristine composite and that of nanotape nanocomposite. The nanotape nanocomposite specimens show much higher G_{E} values not only for NL and VIS points but also for the entire range of the delamination growth. In the case of the pristine composite, the average maximum value of G_{E} is about 570 J/M̂2 while for the case of nanotape nanocomposite the average maximum value of G_{IC} is about 2,658 J/M̂2, i.e., close to about 370% improvement in G_{IC} value has been achieved if composite laminate is manufactured using nanotape which substantially enhances the fracture toughness of the composites.

Table 1 includes G_{IC} values at the NL, VIS points, and the average maximum value of G_{IC} for two typical pristine composites as well as nanotape-reinforced nanocomposites. nanotape increases the Mode I Interlaminar Fracture Toughness of the laminated composite.

TABLE 1

| | GIC at NL | GIC at VIS | Ave Max of GIC |
|---|---|---|---|
| Name | (J/M\hat{ }2) | (J/M\hat{ }2) | (J/M\hat{ }2) |
| Base C-1 | 317 | 573 | 570 |
| Nanotape | 1512.5 | 1671 | 2658 |
| % Improvement | 377% | 191% | 366% |

Fracture surface characterization of the samples showed nanotube pull-out demonstrating the load carrying capability of three dimensionally reinforced composites with nanotapes. Under the DCB loading, these exemplary samples performed about four times better than the base samples.

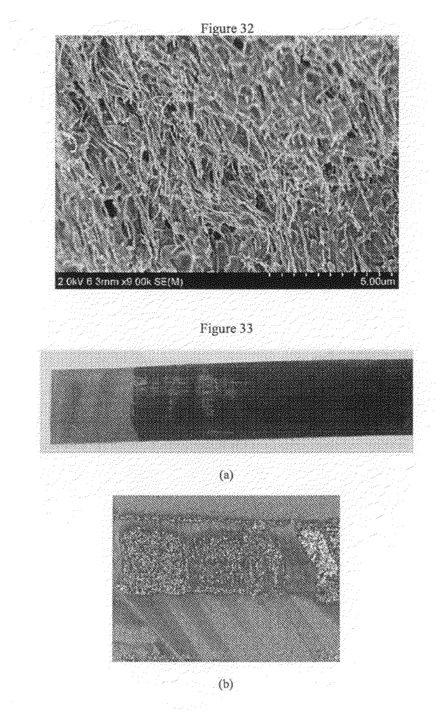

FIGS. 31 and 32 show the SEM images of the DCB fracture surfaces of the nanotape nanocomposites, with low and high resolutions. These figures show CNT pull-out, which is a clear indication of the toughening mechanism.

### 2.1.1.2 Manufacturing and Testing of the DCB Composite Samples Using Nanocarpet-Nanotapes and VA-CNT-NFs Employing a Prepreg Technique

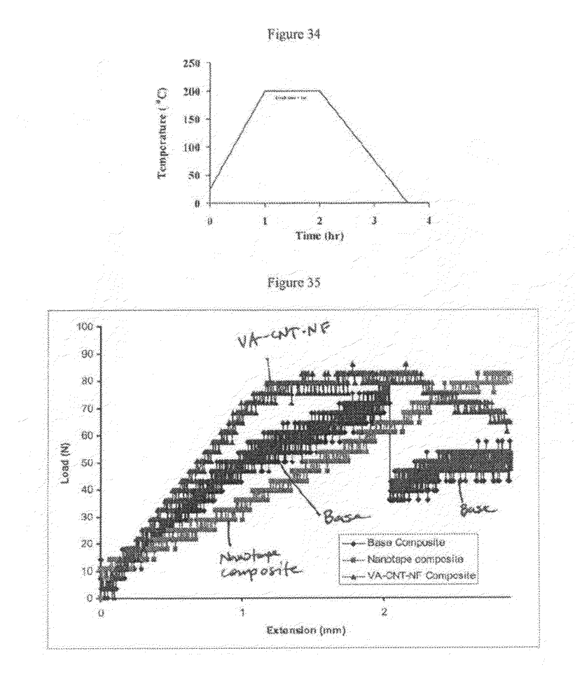

For manufacturing the DCB samples with prepreg, 16 layers of unidirectional carbon fiber epoxy prepregs were used to manufacture the carbon/epoxy base composite. A hand lay-up technique was employed to manufacture the composites in an aluminum 6061 mold. FIG. 33(a) illustrates a prepreg and a nanotape (average 60 μm) placed on it during the manufacturing. Similarly, VA-CNT-NFs (average 60 μm) are placed on the prepreg during manufacturing lay-up (see FIG. 33 (b)).

In some embodiments, a thin layer of matrix materials (of the same material as the prepreg matrix) brushed on the surface of the prepreg before nanotape placement results in a substantial improvement of mechanical properties. For more mechanical results on the thin layer, refer to section 2.1.2.2. The nanotape and VA-CNT-NFs were placed only on the intermediate layer of the composite lay-up where the debond is placed.

The samples were fully laid-up and then placed inside the Compression Molding Machine (Carver Compression Molding Machine, www.carverpress.com), under a uniform pressure of 12,000 psi and heated from room temperature to 200 deg. C. in 1 hour. The samples were held at that temperature for about one additional hour before cooling down to room temperature. The uniform pressure reduced the voids and air pockets that are present within the layers that are laid-up adversely affecting the strength and performance of the specimen, if not extracted. FIG. 34 depicts the cure cycle employed to cure the composite specimens inside the hot press. DCB specimens with nanotapes, VA-CNT-NFs, and base samples were manufactured.

FIG. 26 shows a schematic of a DCB specimen geometry as described by the ASTM standards employing piano hinges. The rest of DCB sample preparations and testing were similar to those explained in the wet lay-up section. The DCB testing procedures here in the prepreg section are the same as those described earlier in the wet lay-up section.

As performed earlier, load versus opening displacement was recorded digitally for the purpose of post-processing for all the DCB specimens tested. FIG. 35 shows a typical load versus opening displacement for the base sample, CNT nanotape sample, and VA-CNT-NFs sample for the prepreg case. The displacement rate for all the samples tested was set at 1 mm/Min. FIG. 35 shows that load increases almost linearly and monotonically till approaching some maximum value of about 70 N for all the specimens.

For the base sample, load dropped monotonically with slight fluctuation as the corresponding opening displacements were increased sharply. At further extension, the load flattened out—without being bound to any single theory, this may be due to new crack propagation. For the nanocomposite specimen with VA-CNT-NFs, the initial load monotonically increased to a linear value of about 70 N. Unlike the base sample, the load extension curve gradually flattened out. With further increase in extension, decrease in load was observed. For the nanocomposite specimen with nanotape, after the initial load reached 70 N, the load further increased due to better load bearing capacity at the interface, as shown from subsequent tests. At each step during loading, the delamination growth length with respect to the point of loading was measured manually through high magnification microscope.

As previously explained, the first G_{IC} is associated with the point where load versus opening displacement deviates from linearity (i.e., NL point). For example in FIG. 35, the NL point associated with the load and the corresponding opening displacement for the base sample is selected at 70 N and 1.5 mm, respectively. The second G_{IC} is associated with the point where delamination initiation is visually observed (i.e., VIS point). For example, in FIG. 35 the VIS point associated with the load and the corresponding opening displacement for base sample is selected at 75 N and 2 mm, respectively. For the DCB specimens tested, delamination growth was slow and stable except for the base sample. Modified Beam Theory method was employed to calculate G_{IC} not only for the NL and VIS points but also for the other remaining points which all required load versus opening displacement curve.

To study the effect of nanotape and VA-CNT-NFs inclusion on the performance of the resulting nanocomposite, nanotape composite and VA-CNT-NFs nanocomposite at the debond interface were manufactured using unidirectional carbon fibers epoxy prepreg. Unidirectional composites specimens were used to perform DCB tests in order to calculate Mode I Interlaminar Fracture Toughness, G_{IC}, in the longitudinal direction employing the ASTM D 5528-01 standard.

All the DCB specimens were manufactured with specific dimensions as provided by the ASTM code as shown in FIG. 26. Three to five samples were tested for each pristine and nanotape composites. For all the specimens, G_{IC} points are associated with the subsequent delamination growth as measured manually with increasing displacement. Modified Beam Theory Method was selected because this method yields the most conservative values for the G_{IC} values with respect to the other methods. The beam expression for the strain energy release rate of a double cantilevered beam is defined as follows and as reported in the ASTM standard. Again, Equation (1) was utilized.

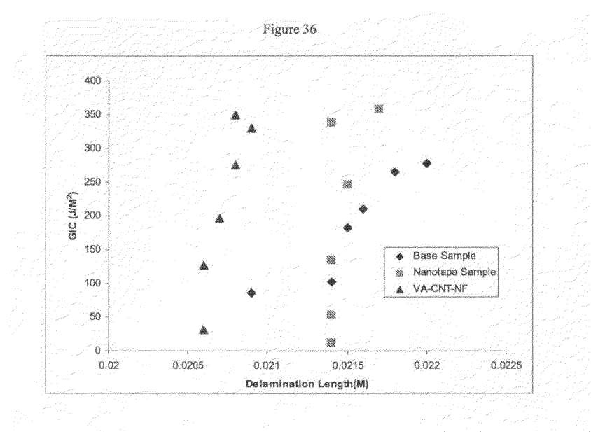

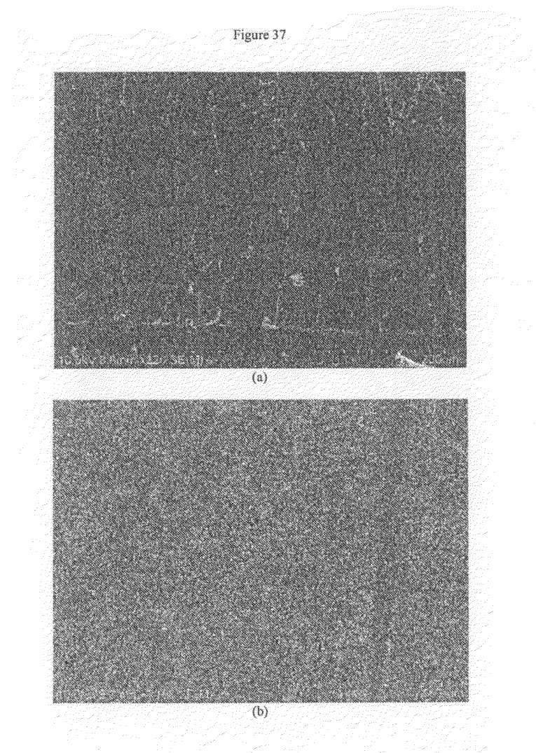

FIG. 36 shows the Delamination Resistance Curve (i.e., R Curve) for a typical base composite, nanotape nanocomposite, and VA-CNT-NFs nanocomposite. The delamination resistance curve defines G_{IC} values as a function of the delamination length. As explained earlier, the first G_{IC} value on the R curve is associated with NL point while the second G_{IC} value is associated with VIS point.

FIG. 36 compares the typical R curve for pristine composite, nanotape nanocomposite, and the R curve of a VA-CNT-NFs nanocomposite. The nanotape nanocomposite specimens, and VA-CNT-NFs Nanocomposites show much higher G_{IC} values not only for NL and VIS points but also for the entire range of the delamination growth. In the case of the pristine composite, the average G_{IC} at NL is about 182 J/M̂2 while for the case of VA-CNT-NFs the average G_{IC} at NL is about 350 J/M̂2.

For nanotape nanocomposite the average G_{IC} at NL is about 453 J/M̂2, i.e., close to about 148% improvement in G_{IC} value has been achieved if composite laminate is manufactured using nanotape which substantially enhances the fracture toughness of the composites. On comparison of nanotape over VA-CNT-NFs for G_{IC} at NL, 29.42% improvement is observed.

In the case of the pristine composite, the average G_{IC} at VIS is about 100 J/M̂2 while for the case of VA-CNT-NFs, the average G_{IC} at VIS is about 276 J/M̂2. For nanotape nanocomposite the average G_{IC} at NL is about 385 J/M̂2, i.e., close to about 286%. On comparison of nanotape over VA-CNT-NFs for G_{IC} at VIS, 40% improvement is observed. Table 2 includes a detailed listing for G_{IC} values at the NL, VIS points for typical pristine composites as well as nanotape-reinforced nanocomposites, and VA-CNT-NFs nanocomposites. The disclosed nanotape-containing materials exhibit improved mechanical properties and the materials significantly increase the Mode I Interlaminar Fracture Toughness of the laminated composite.

Fracture surface characterization of the samples showed nanotube pull-out, demonstrating the load carrying capability of three dimensionally reinforced composites with nanotapes. FIGS. 37(a) and (b) show the SEM images of the DCB fracture surfaces of the pristine nanocomposites, with low and high resolutions, respectively, clearly showing that the composite fails between the plies.

TABLE 2

| | G_{IC} at | G_{IC} at |
|---|---|---|
| | NL | VIS |
| Name | (J/M\hat{ }2) | (J/M\hat{ }2) |
| Base C | 182 | 100 |
| VA-CNT-NF NC | 350 | 276 |
| % Improvement over Base | 92.3% | 176% |
| Nanotape NC | 453 | 385 |
| % Improvement over Base | 148% | 285% |
| % Improvement of | 29.42% | 40% |
| Nanotape over VA-CNT- | | |
| NF | | |

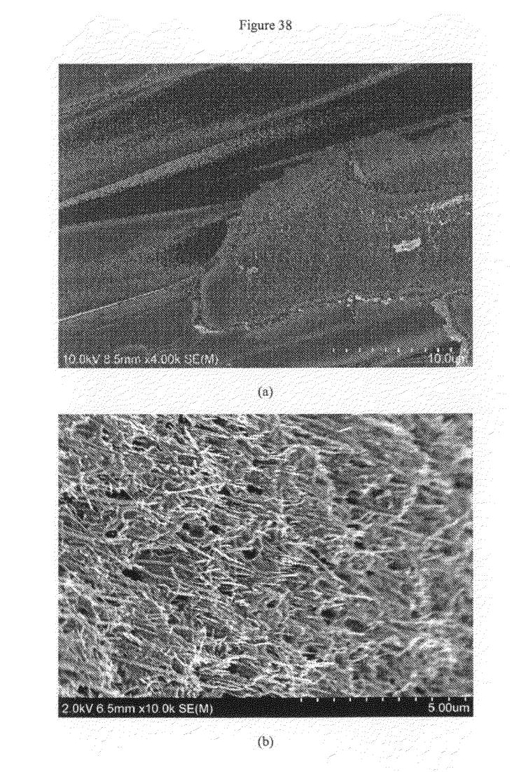

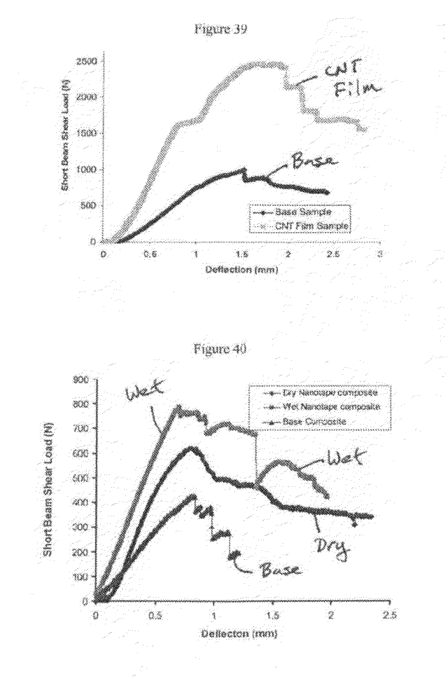

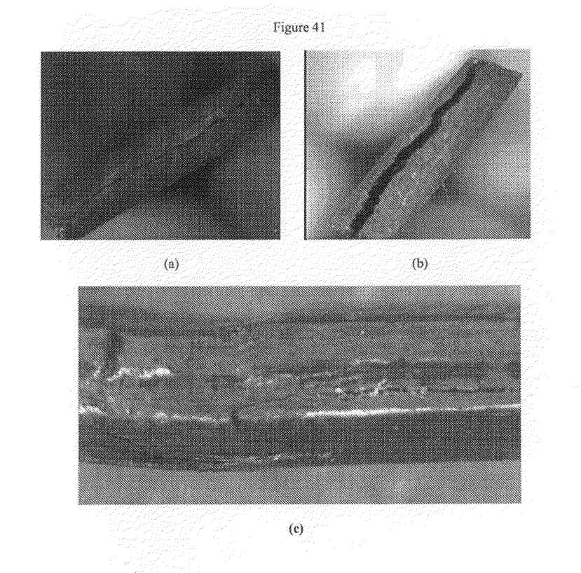

FIGS. 38(a) and 38(b) show the SEM images of the DCB fracture surfaces of the VA-CNT-NFs nanocomposites, and nanotape nanocomposite at high resolutions, respectively, showing that the composite fails between the plies, with nanofoam, and nanotube pull-out which indicates the toughening mechanism in the polymer. However, it can be seen that the nanofoam does not wet properly in VA-CNT-NFs nanocomposite. By contrast, nanotape nanocomposite is wetted out properly, as shown by the abundant nanotube pull-out seen in FIG. 38 (b). The SEM images here provide a good evidence of the improvement in fracture toughness of nanotape nanocomposite over VA-CNT-NFs nanocomposite.

2.1.2 Manufacturing and Testing of the Short Beam Shear Samples using Nanocarpet-Nanotapes

To further verify the superior mechanical performance of the composites that use the disclosed nanotapes, Short Beam Shear tests were performed on samples with and without nanotapes for mechanical characterizations according to the ASTM D 2344. To demonstrate the versatility of the nanotape's applications, Short Beam Shear Samples were manufactured and tested with both wet Lay-up and Prepregging techniques.

### 2.1.2.1 Manufacturing and Testing of the Short Beam Shear Samples Using Nanocarpet-Nanotapes and Wet Lay-Up

For manufacturing the short beam shear samples, 8 layers of 15.9 ft/lb unidirectional carbon fiber tows were used to manufacture the carbon/epoxy base composite. Epoxy resin obtained from Fiberglass Hawaii was used for wetting the fibers. A hand lay-up technique was employed to manufacture the composites in the aluminum 6061 molds. The samples were then put inside a compression molding machine (from Carver Press co.) under a uniform pressure of 12,000 psi and heated from room temperature to 200 deg. C. in 1 hour, and held at that temperature for one more hour before cooling it down to the room temperature. The cure cycle and pressure here were similar to those used in the DCB wet lay-up.

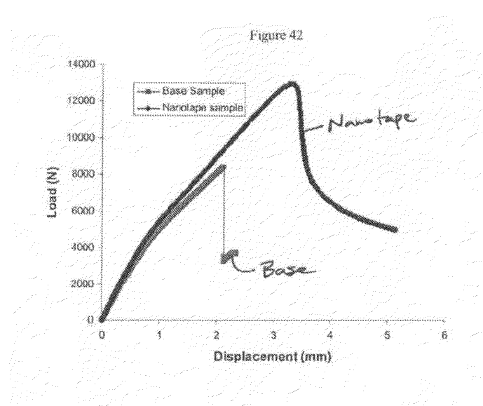

FIG. 39 shows an exemplary short beam shear load versus deflection curve for the base sample and sample with CNT films (nanotape) reinforced in between the unidirectional carbon fiber tows. As shown in the figure, the nanotape samples carried 2.5 times the load of the base sample. However, due to the use of slightly thicker nanotape samples, a 70% improvement in the nanotape nanocomposite is observed over the base composite. The values for the shear strength for the base and nanotape nanocomposite are shown in Table 3. These results can be correlated to the fracture surface in FIG. 38(b). Also, as seen in the load deflection curve, nanotape samples have a higher modulus than base sample.

TABLE 3

| | Base | Nanotape | % |
|---|---|---|---|
| | Composite | Composite | Improvement |
| Short | 26.8 | 45.44 | 69.55% |
| Beam | | | |
| Shear | | | |
| Strength | | | |
| (MPa) | | | |

### 2.1.2.2 Manufacturing and Testing of the Short Beam Shear Samples (SBS) Using Nanocarpet-Nanotapes and Prepreg

For manufacturing SBS samples with prepreg, 12 layers of unidirectional carbon fiber epoxy prepregs were used to manufacture the carbon/epoxy base composite. A hand lay-up technique was employed to manufacture the composites in an aluminum 6061 mold. For SBS samples, nanotapes (average 60 μm) were placed on prepreg during the manufacturing (see FIG. 33(a)). Similarly, a thin layer of matrix materials (of the same material as the prepreg matrix) is brushed on the surface of the prepreg before placing the nanotape on it. When no matrix was applied to the prepreg, the nanocomposite is classified as dry nanotape composite. If a thin layer of matrix material is applied, the nanocomposite is classified as a wet nanotape composite. Sample were tested under each category.

FIG. 40 shows a typical short beam shear load versus deflection curve for the base sample and sample with CNT nanotape films reinforced in between the unidirectional carbon fiber tows with and without a thin layer of resin. As shown in the figure, the nanotape samples were classified as wet adhesive carried maximum load due to proper wetting of nanotape. The dry nanotape nanocomposite performed better than the base sample. However, due to lack of enough resin for wetting, the dry nanotape nanocomposite was inferior to the wet nanotape nanocomposite. The values for the shear strength for the base, dry nanotape nanocomposite, and wet nanotape nanocomposite are shown in Table 4. Also, as seen in the load deflection curve, nanotape samples have a higher modulus than base sample.

TABLE 4

| | | Dry | Wet |
|---|---|---|---|
| | Base | Nanotape | Nanotape |
| | Composite | Composite | Composite |
| Short Beam | 28.83 | 36.89 | 42.22 |
| Shear | | | |
| Strength | | | |
| (MPa) | | | |
| Improvement | — | 27.95% | 46.44% |

FIG. 41 shows fracture surfaces of different SBS samples. FIG. 41(a) depicts the fracture surface of a base SBS sample failed near to the center of sample thickness. This failure is mainly promoted by interply shear. The failure of the sample near the center line demonstrates that the sample is strong both in tension and compression. FIG. 41(b) shows an optical micrograph of the fracture surface of dry nanotape SBS sample, which figure shows the sample is stronger in compression. FIG. 41(c) shows an optical micrograph of the fracture surface of wet nanotape SBS sample as a front view. The failure mode of dry SBS sample is similar to the wet SBS sample.

### 2.1.3 Manufacturing and Testing of the Tensile Samples Using Nanocarpet-Nanotapes and Wet Lay-Up

For manufacturing samples for tension testing, 3 layers of 15.9 ft/lb unidirectional carbon fiber tows were used to manufacture the carbon/epoxy base composite. Epoxy resin obtained from Fiberglass Hawaii was used for wetting the fibers. A hand lay-up technique was employed to manufacture the composites in the aluminum 6061 molds. The samples were then put inside the Compression Molding Machine under a uniform pressure of 12,000 psi and heated from room temperature to 200° C. in 1 hour, and held at that temperature for one more hour before cooling it down to the room temperature. The cure cycle and pressure here were similar to those used in the DCB wet lay-up. For tension samples with nanotape, similar manufacturing procedure used in section 2.1.2.1 is used.

FIG. 42 depicts a typical load vs. extension curve from the tension samples tested. Its obvious from the graph that the base composite and nanotape composite have very similar stiffness values. Table 5 shows the improvement in tensile strength and strain to failure of nanotape nanocomposite over base composite. The strength of the nanotape-composite increased by 46%, and the strain failure increased by 66%.

TABLE 5

| | Base | Nanotape | % |
|---|---|---|---|
| | Composite | Composite | Improvement |
| Tensile Strength | 747.36 | 1092.66 | 46.11% |
| (MPa) | | | |
| Strain To Failure | 0.02128 | 0.0348 | 63.53% |
| (mm/mm) | | | |

### 2.1.4 Manufacturing and Testing of the Flexure Samples Using Nanocarpet-Nanotapes and Wet Lay-Up

For manufacturing flexure samples, 10 layers of 15.9 ft/lb unidirectional carbon fiber tows were used to manufacture the carbon/epoxy base composite. Epoxy resin obtained from Fiberglass Hawaii was used for wetting the fibers. A hand lay-up technique was employed to manufacture the composites in the aluminum 6061 molds. The samples were then put inside the Compression Molding Machine under a uniform pressure of 12,000 psi and heated from room temperature to 200° C. in 1 hour, and held at that temperature for one more hour before cooling it down to the room temperature. The cure cycle and pressure here were similar to those used in the DCB wet lay-up. For flexure samples with nanotape, similar manufacturing procedure used in section 2.1.2.1 is used.

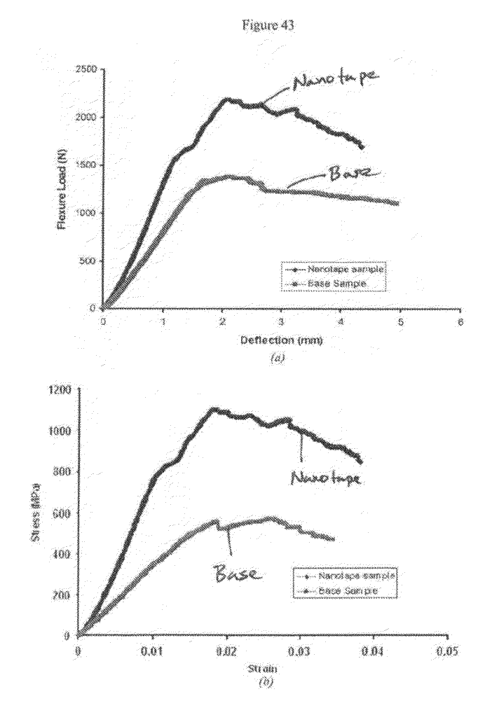

FIG. 43(a) depicts an exemplary load vs. extension curve from the flexure samples tested. The base composite had lower stiffness when compared with stiffness of nanotape nanocomposite. FIG. 43(b) shows an exemplary stress vs. strain curve obtained from the flexure test. Table 6 shows the improvement in flexural strength of nanotape nanocomposite over base composite.

TABLE 6

| | Base | Nanotape | % |
|---|---|---|---|
| | Composite | Composite | Improvement |
| Flexural Strength | 583 | 1099 | 88.5% |
| (MPa) | | | |

### 2.1.5 Manufacturing and Testing of the Composite Samples Using Nanocarpet-Nanotapes and Wet Lay-Up for Damping Applications

In addition to the large-scale improvements in mechanical properties, the nanotape composite also shows superior multifunctional performances such as damping. Damping is the dissipation of vibrational energy under cyclic loading. Inducing damping in a structure would essentially improve the fatigue life of the system.

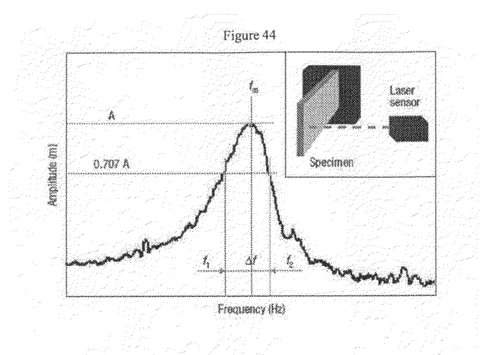

Provided are measurements (see FIG. 44 and Data reduction) and comparisons of the natural frequencies as well as the damping ratios of the nanotape composite with those of its counterpart using a cantilevered-specimen (see inset FIG. 44) experiment.

The samples were manufactured from the tension samples with the dimensions of 60 mm×12 mm×1 mm. Table 7 compares the results of structural dynamic properties of the nanotape composite as well as the base composite, where fn and ξ are the natural frequency and damping ratio, respectively. The nanotape-fastened nanocomposite has improved ξ by 101% compared with the base composite (see Table 7). In addition, the damping characteristics, fnξ, enhancement is more than two times (that is, 206%) for the nanotape composite compared with the base counterpart. This result is very encouraging for the use of nanotape nanocomposites in many structural areas where structural damping is highly desired.

TABLE 7

| | | Nanotape |
|---|---|---|
| | Base Composite | Nanocomposite |
| ƒm (Hz) | 204 | 341 |
| .ζ | 0.029425 | 0.094532 |
| Damping Factor | 113 | 581 |
| % Enhancement | — | 414% |

Structural dynamic analysis and data reduction. In the experimental set-up, the specimen was cantilevered, as shown in FIG. 4a inset. The free end is initially moved to a given position and then released, causing the free vibration of the specimen. The displacement at the free end of the specimen is monitored by a laser displacement sensor, recorded and transformed into frequency domain by employing a dynamic signal analyzer (see FIG. 44). A typical amplitude-frequency curve is illustrated in FIG. 4a. From this curve the natural frequency

From this curve the natural frequency From this curve the natural frequency fn and damping ratio ξ can be calculated using Eqs. (S1) and (S2)

$$\begin{matrix}{f}_{n} = \frac{1}{\sqrt{1 - 2 {ζ}^{2}}} {f}_{m} & ( S 1 ) \\ ζ = \frac{{f}_{2} - {f}_{1}}{2 {f}_{m}} = \frac{Δ f}{2 {f}_{m}} & ( S 2 )\end{matrix}$$

where fm is the frequency at which the amplitude is maximum, i.e., A in FIG. 44; f1 and f2 are the two frequencies at which the amplitude is 0.707 times of its maximum, and Δf is the difference between f1 and f2, also called half-power bandwidth. If ξ<<1, then fn=fm. In addition, the damping is proportional to the product of fn and ξ.

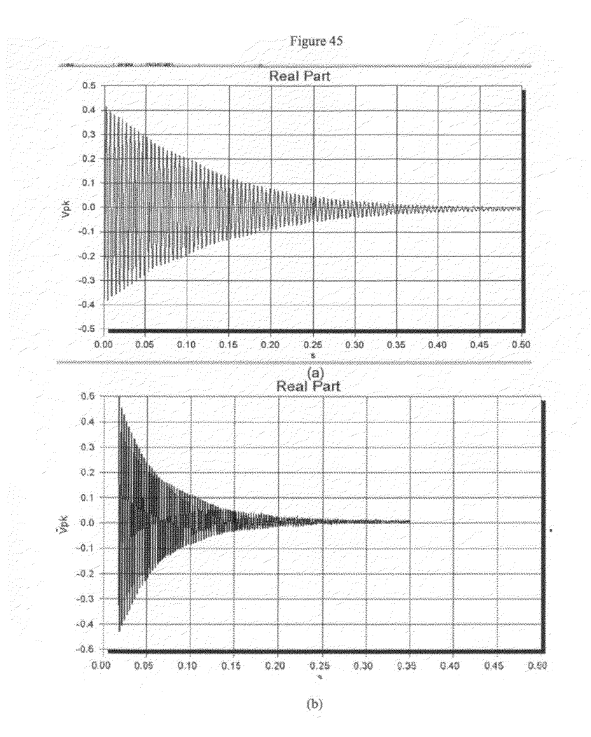

FIG. 45(a) and FIG. 45(b) are exemplary time vs. amplitude recordings measured for characterizing the samples for damping.

### 3. Adhesive Applications of Nanotapes

Although adhesive bonding to join various materials is advantageous (such as low cost, high strength to weight ratio, and fewer parts and processing requirements), the adhesives can be weaker than the adherends they join. Presented here is reinforcement by aligned nanofilms (e.g., carbon nanotube nanofilms) used as adhesive joints for composite adherends. Virtually any commercially available adhesive can be reinforced by nanofilm to create a strong adhesive.

Presented are exemplary results of using vertically aligned multi-walled carbon nanotube (MWCNT) nanofilms as adhesive reinforcements to enhance the adhesive shear strengths of carbon/epoxy composite joints. The reinforced MWCNT adhesive nanofilms are used to bond the carbon/epoxy composite adherends. Mechanical characterization of the samples is performed using single lap joint test (ASTM D 5868-01) to measure average shear strengths experimentally.

### 3.1 Manufacturing, Assembly, and Testing

70-micrometer aligned MWCNT nanofilms were grown on a silicon or silicon oxide substrate employing chemical vapor deposition. A gaseous mixture of ferrocene (0.1 g), as a catalyst source, and xylene (10 mL), as a carbon source, was preheated to 185° C. and passed over the substrate placed inside the furnace at 800° C. for 20 mins with the help of argon gas.

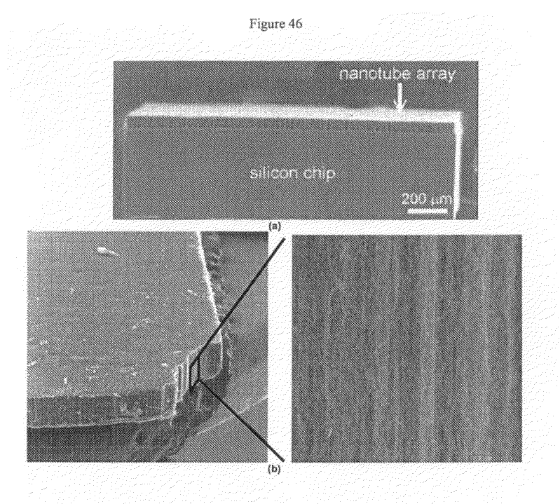

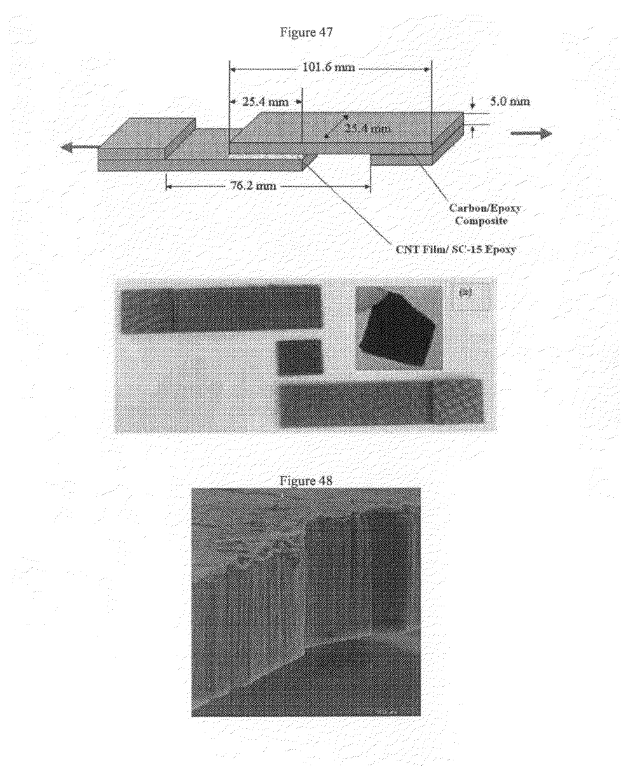

The MWCNTs grew selectively on the substrate with controlled thickness and length. FIG. 46 shows the growth of well-aligned MWCNT nanofilms on a silicon substrate and its scanning electron microscope (SEM) image. Diluted Hydrofluoric acid is used to etch the CNT nanofilms from the silicon oxide substrate (see inset in FIG. 47b).

The second step is to manufacture the carbon/epoxy composite adherends. Eight layers of satin weave prepregs obtained from Hexcel (www.hexcel.com) were used to manufacture the carbon/epoxy composite. A hand lay-up technique followed by vacuum-bagging and autoclaving was employed to manufacture the composites.

A quasi-isotropic stacking sequence was used for the composites lay-up. The dimensions used for cutting the composite sample and the fabrication of nanotube nanofilms sizes are followed according to ASTM standard D5868. FIG. 47(a) depicts the dimensions of the samples used in the shear test. SC-15 epoxy resin and hardener obtained from Applied Poleramic is used as the adhesive between the adherends.

Single lap joint samples are assembled using carbon/epoxy adherends and SC-15 epoxy resin reinforced by vertically aligned MWCNT nanofilms. Three samples were tested with and without MWCNT nanofilms for comparisons. The relative speed of 13 mm/min is used to test the samples being pulled away. The single lap adhesion samples were post-cured in the oven at 150° C. for 120 min. The completely cured adhered samples were tested by using an Instron testing machine.

### 3.2 Results

The average shear strength of the bonding area was obtained by dividing the peak tensile force by the lapped area. Three samples were tested for average shear strengths of specimens with and without VA-CNT-NFs.

The pure samples had an average shear strength of 14 MPa, while the samples reinforced with aligned CNT nanofilms possessed slightly lower average shear strength of 12 MPa. FIG. 48 depicts a Scanning Electron Microscope (SEM) image of an VA-CNT-NFs as manufactured and used to reinforce the adhesive for adherends. It is observed from the (SEM) image that a thin layer of Fe catalyst particles adhered to the MWCNT nanofilm (at the top surface in FIG. 48). This layer normally forms on the substrate upon which the CNTs grow. When the MWCNT nanofilms are separated from the substrate, this thin Fe layer come off the substrate and is attached to the MWCNT nanofilm. This results in lower shear strength due to improper interface between the MWCNT nanofilm and the adherends.

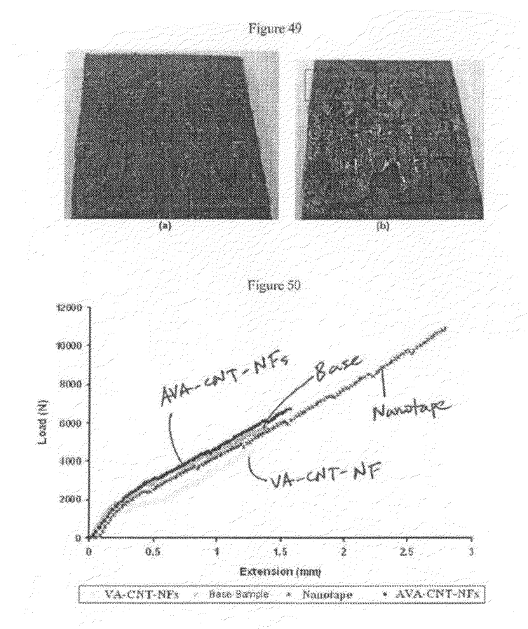

FIGS. 49(a) and (b) depict typical fracture surfaces of the composites after testing for pure resin and the resin reinforced by the VA-CNT-NFs, respectively. As shown in these figures, samples with pure resin failed under cohesive failure (i.e., a rupture of the adhesively bonded joint, such that the separation is within the adhesive layer (see FIG. 49a). Examination of the fracture surface of the sample reinforced by the VA-CNT-NFs indicates an adhesive failure or a thin-layer cohesive failure at the interface between the VA-CNT-NFs and the composite adherend (see FIG. 49b). This type of failure is also known as interface failure. Without being bound to any single theory, the catalyst layer on the CNT nanofilm may have caused such a failure.

### 3.2.1 Adhesive Shear Strength

A single lap joint test was used to find the average shear strength of the adhesive samples with and without VA-CNT-NFs. Three samples were tested for average adhesive shear strengths of the specimens. The pure samples had average shear strength of 14 MPa, while the samples reinforced with VA-CNT-NFs possessed average shear strength of 12 MPa.

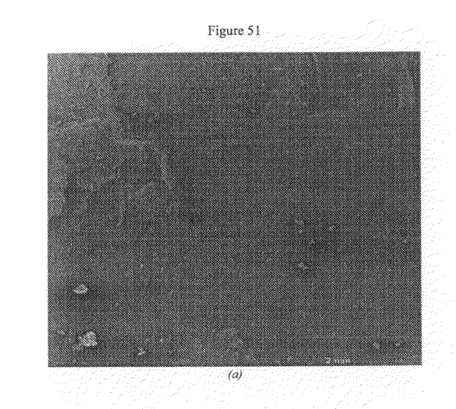

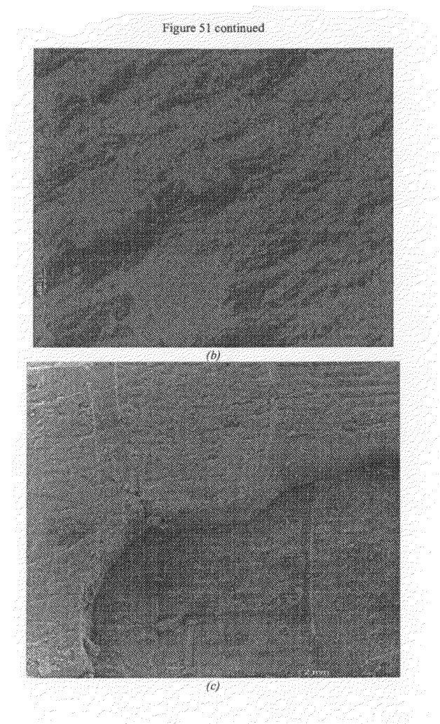

Further testing was done using nanotape films and acid treated VA-CNT-NFs (AVA-CNT-NFs). FIG. 50 depicts the typical load deflection curves for all four different kind of samples tested for adhesive shear loading using lap-joint test. The average shear strength for samples with AVA-CNT-NFs was better than for the base sample.

The load-deflection curve represents an increase in load taken. For nanotape films, the load carried almost doubled. The average adhesive shear strengths of samples with AVA-CNT-NFs was 15 MPa, while the average adhesive shear strength for nanotape films was 25 MPa (see Table 8.). The increase in adhesive shear strength for nanotape adhesive is due to proper load transfer between the carbon nanotubes and adhesive due to the alignment of CNTs in horizontal direction as seen in the load-deflection curve.

TABLE 8

| | | VA- | AVA- | |
|---|---|---|---|---|
| | Base | CNT- | CNT- | Nanotape |
| | Composite | NFs | NFs | Composite |
| Adhesive Shear | 13.7 | 12 | 15 | 25.4 |
| Strength (MPa) | | | | |
| Strength | | −12.4% | 9.5% | 85.4% |
| Enhancement % | | | | |

### 3.2.2 Adhesive Fracture Surface Characterization

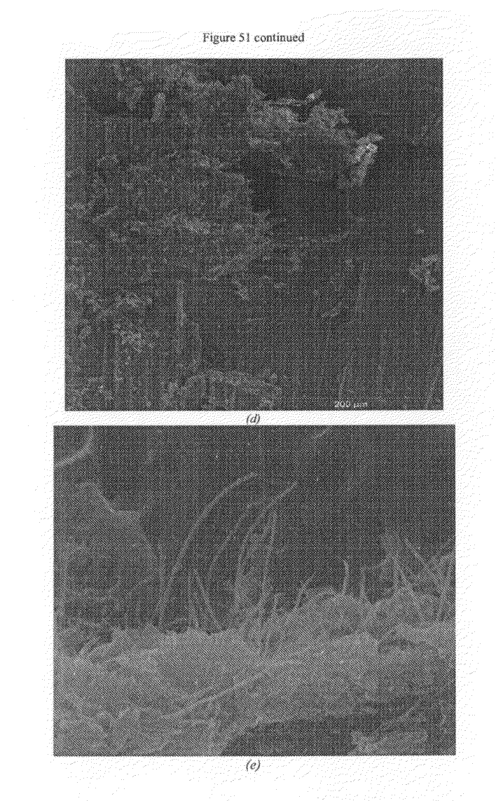

To further characterize the samples, fracture surfaces of all the four samples were observed using a SEM. FIG. 51(a) is a low magnification image of pure epoxy sample. Inset shows high magnification image of the fracture surface. From the fracture surface it is seen that the sample failed under cohesive failure (rupture of the adhesively bonded joint, such that the separation is within the adhesive, see 51 (b)).

Review of the fracture surface of VA-CNT-NFs resin sample indicates adhesive failure or thin-layer cohesive failure at the interface between the VA-CNT-NFs and the composite adherend (see FIG. 51 (c)). From FIGS. 51(a), (b), and (c), it is seen that the VA-CNT-NFs failed at the interface of CNT film and the composite adherend. Both the fracture surfaces agree well with the load displacement curve in FIG. 50.

Fracture surface 51(d) shows a mixed failure mode between cohesive failure and adhesive failure at the interface between AVA-CNT-NFs and adhesive. The overall wettability of this CNT film is much better than the VA-CNT-NFs without acid treatment. The increase in load carrying capability may be due to the better wettability characteristics of the AVA-CNT-NFs in certain areas as seen in FIG. 51(d). FIG. 51 (e) shows partial nanotube pull-out, which could have contributed to the excess load carried by this adhesive as seen from the load deflection curve.

Raman spectroscopy may be used to evaluate stress transfers by monitoring peak shifts under strain. Calculations simulating pull-out tests of SWNTs show interfacial shear stresses in the 100-160 MPa range.

TEM is also utilized to show evidence that high interfacial shear strength exists between MWNTs and epoxy. Atomic force Microscope (AFM) is a technique used to measure interfacial strength. With this technique, CNTs show an interfacial strength of about ten times larger than regular carbon fiber and polymer mixture. The average interface strength of a single carbon fiber pull-out contributes around 5 MPa in shear strength, whereas, a single MWNT pull-out has an average interface strength of around 50 MPa. However this interface strength transfers into the bulk composite properties only when there is a uniform nanotube pull-out observed in the composite.

Looking at the fracture surface of nanotape film adhesive it is seen that the sample failed under cohesive failure, like a pure epoxy sample (see FIG. 51 (f)). A phenomenon similar to micro-fiber pull-out at the nano level was observed as seen from FIG. 51 (g). Previous work has established that strength in nanocomposites can be increased at the nanotube interface due to such nanotube pull-out. From the fracture surface, it, is seen that nanotube pull-out is abundant and uniformly distributed through out the sample (see FIG. 51 (g)). This explains the increase in mechanical performance in shear strength. It is seen in both the fracture surface and the load-deflection curve that nanotape film provides excellent nanotube matrix interface contributing directly to the bulk adhesive properties in composite.

### 4. Typical Mechanical Joints And Composite Panels With Cut-Outs Applications Of Nanocarpet-Nanotapes

Composite materials in primary load bearing structures have a requirement for holes being drilled for bolting and riveting. Drilled holes significantly reduce the performance of composites. Nanotapes can be used to increase the residual strength of drilled in hole composites. In the past, molded-in holes were used to increase the residual strength of the structure.

### 4.1 Manufacturing and Testing of Drilled in Hole Nanotape Nanocomposites Under Tension

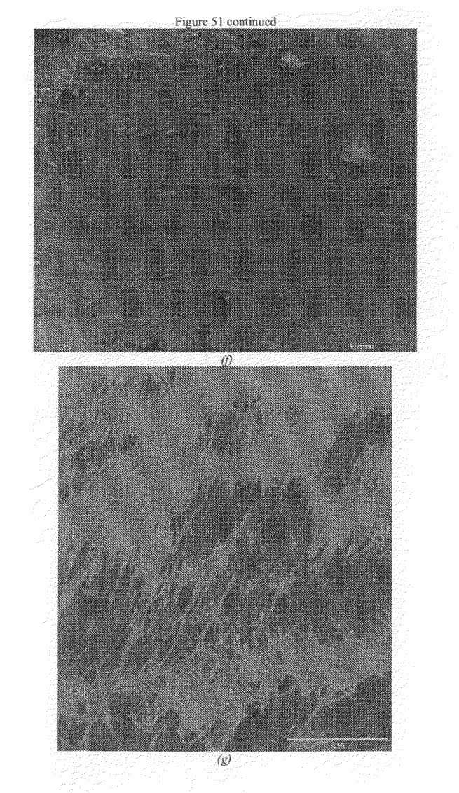

For manufacturing the tension samples with prepreg, 4 layers of unidirectional carbon fiber epoxy prepregs were used to manufacture two sets of carbon/epoxy base composite (one un-notched, one notched). A hand lay-up technique was employed to manufacture the composites in an aluminum 6061 mold. FIG. 52(a) shows a prepreg and a nanotape (average 60 μm) placed on it during the manufacturing to increase the residual strength of drilled in holes.

Three samples were tested for each case. FIG. 52(b) shows base composite with un-notched hole. FIG. 52(c) shows base (at right) and nanotape (at left) composites with drilled in holes. The holes are 8.5 mm wide and the composites are 25.4 mm wide.

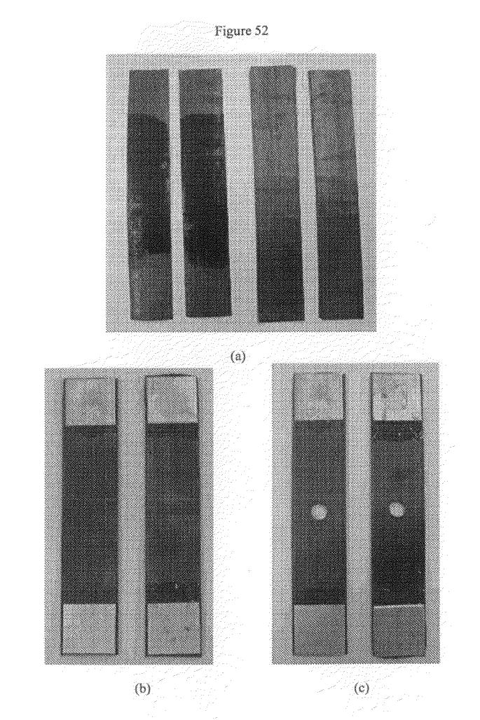

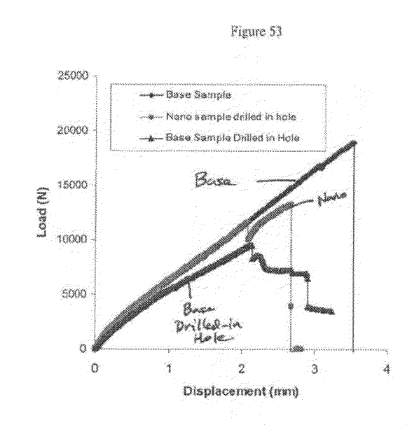

FIG. 53 shows typical load vs. deflection curves for base sample un-notched, base sample with drilled in hole (8.5 mm wide), and nanotape sample with drilled-in hole. From the load deflection curves, it is seen that the base sample has the highest residual strength. For the base sample with drilled in hole, 44% of residual strength is retained. For the nanotape sample with drilled in hole, 68% of the residual strength is retained (see Table 9). From Table 9, it is clear that the nanotape samples decrease the stress concentration of drilled in hole samples from 2.3 to 1.48. By comparison, nanotape nanocomposite performs better than molded-in holes in terms of stress concentration factor and residual strength retained. From the load vs. displacement curve, it is seen that nanotape composite performs better even after a decrease in load due to cracks or delamination. The load bearing capacity of the base composite, however, drastically decreases henceforth.

TABLE 9

| | Base | Base | Nanotape |
|---|---|---|---|
| | Composite | Composite | Composite |
| | unnotched | notched | notched |
| Tensile Strength | 1490.55 | 652.47 | 1007.605 |
| (MPa) | | | |
| Strain To Failure | 0.0212 | 0.0275 | 0.035 |
| (mm/mm) | | | |
| Stress | 1 | 2.30 | 1.48 |
| Concentration | | | |
| Factor | | | |
| (σ_{N}/σ_{O})*100 | 1 | 44% | 68% |
| Stress | 1 | 2.27 | 1.64 |
| Concentration | | | |
| Factor from Ref | 1 | 44% | 61% |
| (σ_{N}/σ_{O})*100 | | | |

FIG. 54 shows the fracture of un-notched and drilled in samples after tension. The un-notched base sample shattered into lots of pieces due to even stress concentration all over the sample. However, looking at the drilled in base sample it is seen that the stress concentration arises from the drilled hole edge. On the contrary for nanotape nanocomposite sample, no such failure is observed. This is primarily due to the high load bearing capability of nanotape nanocomposite around the stress concentration areas of drilled in holes.

### 5. Thermal Conductivity, Thermal Expansion, and EMI Shielding

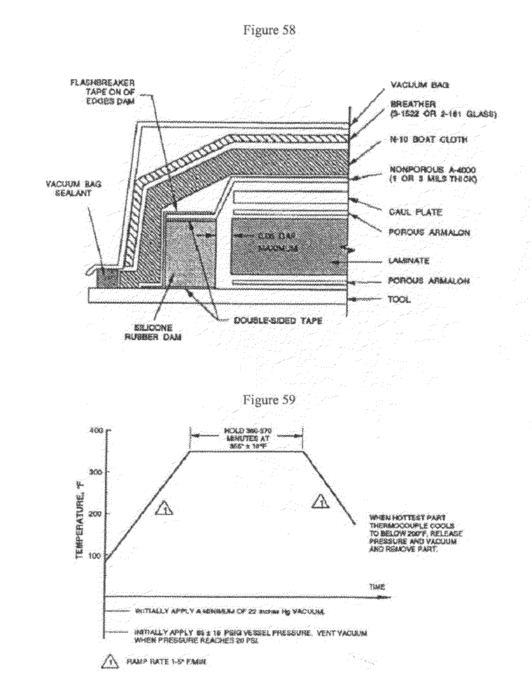

The thermal conductivity, thermal expansion, and EMI shielding performance of the nanotape materials were also evaluated. Six layers of 5-inch×5-inch AS4/977-3 unidirectional carbon fiber epoxy prepregs were used to manufacture the carbon/epoxy base composite according to the lay-up sequence shown in FIG. 58. Nanotapes (averaging about 40 micrometers in thickness) were placed on the prepreg during the manufacturing lay-up for the modified samples. The samples were cured according to the cure profile shown in FIG. 59.

Thermal Conductivity:

The thermal conductivity tests were performed according to the specifications of ASTM E 1530 Test Method. The estimated accuracy of the tests is +/−3%.

The table below shows the thermal conductivity results for the base and nanotape-modified samples in the z-direction. As seen in the results, due to the higher thermal conductivity of CNTs, the nanotape-modified samples exhibited better thermal conductivity over the base samples. The increase in thermal conductivity varied from 35% at room temperature (25° C.) to 41.4% at 150° C.

TABLE 10
Thermal Conductivity for Base and
nanotape-Modified Samples in Z-direction.

| | Temperature | Thermal Conductivity |
|---|---|---|
| Specimen | (° C.) | (W/(m K)) |
| Composite Base | 25.1 | 0.74 |
| Z direction | 75.3 | 0.80 |
| | 150.2 | 0.87 |
| Composite Modified | 25.1 | 1.00 |
| Z direction | 73.1 | 1.09 |
| | 149.7 | 1.23 |

Coefficient of Thermal Expansion (CTE):

Thermal expansion tests were performed according to the specifications of ASTM E228 Test Method. The instrument used for these tests was a fused silica dilatometer, able to perform thermal expansion measurements on reference material with an expanded uncertainty of about +/−1.5% for a 95% confidence level. The standard thermal expansion specimen length was 2 inches. The X-direction specimens were machined as single pieces, 2 inches long. Due to experimental limitations, the thermal expansion specimens in the Z-direction had pieces machined and stacked for testing to obtain specimen length of 1 inch.

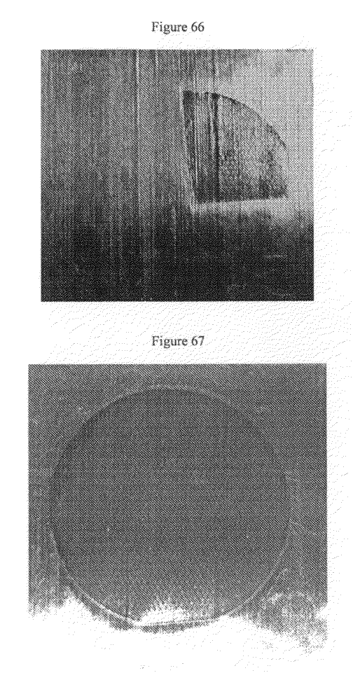

All the specimens were tested from −150° C. to 150° C., in an air atmosphere, with a heating rate of 2° C./min—FIGS. 65 and 66 show specimen behavior during the tests. The tabulated values of percent expansion and coefficients of thermal expansion versus temperature were obtained by fitting fourth order polynomial curves to the heating portion of the experimental data. Due to the behavior of specimen composite base Z-direction, tabulated values were obtained up to 100° C.

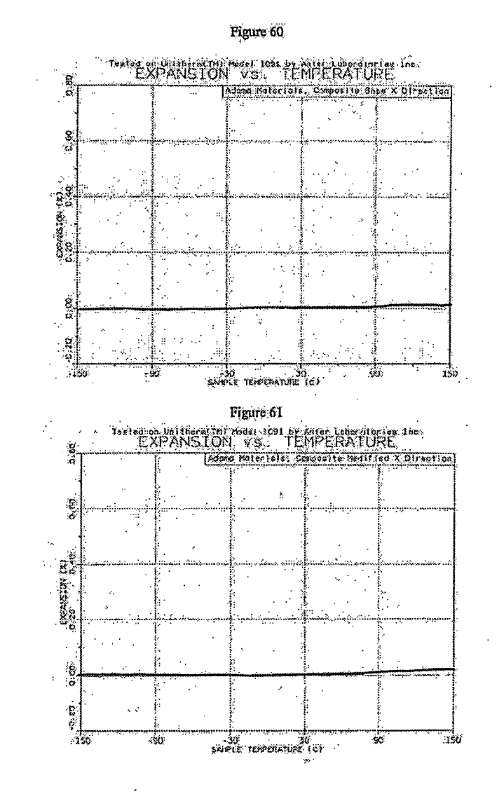

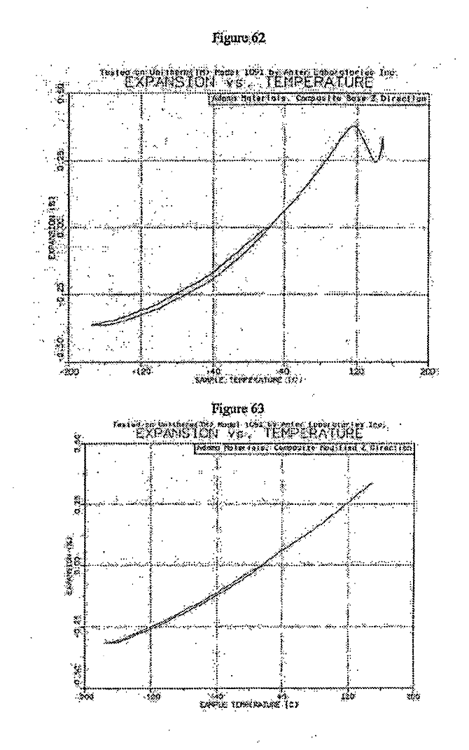

FIGS. 60 and 61 show the thermal expansion for base and nanotape-modified samples in X-direction, respectively. As it is seen in the graphs, there is no major difference between the expansions for the sample in X direction. FIGS. 62 and 63 show thermal expansion for base sample and modified sample in the z-direction. The modified sample expansion is less than the base sample showing better dimensional stability. The average coefficient of thermal expansion of base sample was 60% more than the coefficient of thermal expansion of the modified sample at 100° C.

For all practical purposes, the CTE for the X-direction remain at about zero for both Base and nanotape-Modified samples. Without being bound to any single theory, one reason for this result is that in the X-direction the CTE is dominated by the Carbon fiber with much higher volume fraction than the MWCNT-contained nanotapes. The epoxy system has positive CTE. The MWCNTs have negative CTE in both X- and Z- (i.e., longitudinal and transverse) directions. However, while the Carbon fiber has negative CTE in the X- (i.e., longitudinal) direction, it has positive CTE in the Z- (i.e., transverse) direction. Therefore, the effect of nanotape on the laminate CTE is conspicuous in the Z-direction. FIG. 5 shows that the CTE for the Base sample varied from 20.558E-6PC to 36.992B-61° C. when the temperature changed from −150° C. to 100° C. Nanotape-modified nanocomposites' CTE changed from 17.946E-6/° C. to 25.713E-6PC. The average of the CTE between 0° C. to 100° C. was about 40E-6/deg. C. for the Base Composites and 25E-6/deg. C. for the nanotape-Modified nanocomposites, resulting in a ˜40% reduction in CTE.

ElectroMagnetic Inteference (EMI) Shielding (Electrical Conductivity):

The disclosed nanotapes are desirable as a suitable alternative to metals for their use of composites where higher electrical conductivity is needed, such as EMI shielding and lightning protection applications.

TABLE 11
EMI Shielding Effectiveness (SE) of the Base,
Modified 1, and Modified 2 Samples.

| Test Frequency (GHz) | Base 1 | Modified 1 | Modified 2 |
|---|---|---|---|
| 2 | 15 | 27 | 25 |
| 4 | 26 | 23 | 26 |
| 6 | 27 | 27 | 33 |
| 8 | 29 | 32 | 27 |
| 10 | 24 | 23 | 29 |
| 12 | 24 | 23 | 28 |
| 14 | 28 | 27 | 32 |
| 16 | 26 | 32 | 32 |
| 18 | 25 | 24 | 29 |
| Average Shielding | 24.89 | 26.44 | 29 |
| Effectiveness | | | |

In the above table, base 1 is the Composite made of unidirectional carbon/epoxy prepreg. Modified 1 is the same as Base 1 plus one layer of nanotape on the top surface. Modified 2 is Modified 1 plus nanotapes inserted into every intermediate layer. Table 11 shows the average EMI shielding effectiveness of the Base and Modified samples with nanotapes. Shielding effectiveness is one means for assessing the EM radiation absorption and/or reflection capacity of the EMI shielding composites.

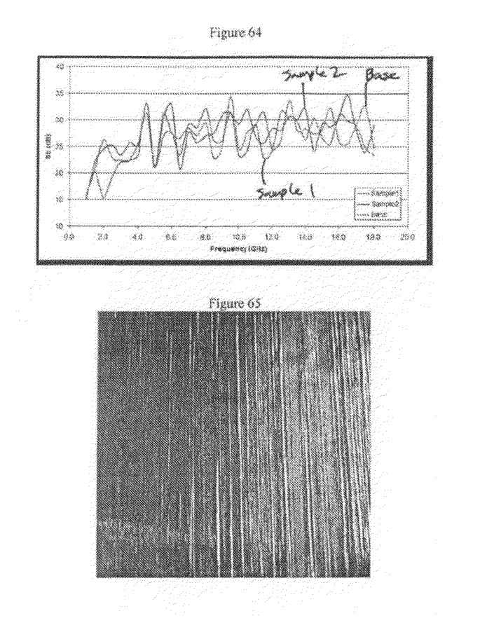

The composite panels would be capable of absorbing electromagnetic radiation, reflecting electromagnetic radiation, or combination thereof in a frequency range between 1 GHz to about 18 GHz, wherein the EM shielding capacities of the Base and Modified composites, measured as electromagnetic interference (EMI) shielding effectiveness (SE) have the average values of 24.89, 26.44, and 29 decibels (dB) for the Base, Modified 1, and Modified 2 samples, respectively, demonstrating that the nanotapes improve the EMI shielding of the Nanbocarpet-nanotape-based nanocomposites. FIG. 64 is the graphical demonstration of Table 11.

6. Fuel Cells and Gas Diffusion Layers

The disclosed nanotapes are also useful as gas diffusion layers, which layers may in turn be used in fuel cells. Gas Diffusion Layers (GDLs) enhance the delivery of gases to the catalyst layers by controlling the water in the pore channels while simultaneously completing the electronic circuit needed to deliver the power generated by the Proton Exchange Membrane (PEM) Fuel Cells.

Proton Exchange Membrane Fuel Cells (PEMFCs) are useful power providing devices for stationary and portable devices. To achieve higher operating efficiencies, PEMFCs are operated at elevated temperatures, around 70° C. Operation at this elevated temperature requires extensive humidification of gases, particularly when using ambient air at the cathode. Reducing the humidification requirements increase efficiency by allowing simplified humidification methods. Gas diffusion layers (GDLs) manage water in the cell as well as promote gas flow to the catalyst.

Existing carbon paper products for the GDLs offer limited hydrophobic characteristics, and are hence enhanced by a Teflon™ PTFE coating on the surfaces of the carbon paper. Vertically aligned carbon nanotube nanoforest nanofilm directly assembled on carbon paper may be used as a GDL alternative, which modification substantially improves both the hydrophobic nature of the carbon paper and its porosity in the fuel cell as well as enhances the electrical conductivity and the electron/proton conduction. In a fuel cell configuration, the PTFE serves as a binder and provides hydrophobicity to the electrode structure. However, the incorporation of the PTFE in the electrode will cover/wrap some catalyst sites, thus lowering the mass activity of Pt catalyst.

GDLs prepared by existing technology exhibit major performance losses at elevated temperatures and low humidities. By contrast, GDLs using the disclosed nanofilm materials show no performance loss when operated at elevated temperatures with lower humidity conditions in addition to the enhancement in peak power density. By comparison to existing GDL materials, the disclosed GDL materials (1) require lower humidity due to its hydrophobic nature that repels humidity towards the PEM, hence reducing the size, weight, and cost of the humidity generator, (2) last longer since it does not absorb humidity, and hence does not degrade in performance over time, (3) provide better electrical conductivity, and (4) increase peak power density. As a result, the novel disclosed GDL materials enhance performance, durability, and efficiency of PEM fuel cells while reducing cells' size, weight, and costs as compared with current technology.

The disclosed VA-CNT-NF (Vertically-Aligned CNT Nanoforest Nanofilm) material has high mass and electron transfer due to the unique morphology of CNTs. An aligned CNT film has unique advantage over dispersed CNTs or CNTs grown in-situ on a carbon paper with non-uniform microscopic surface. First, the electrical conductivity of the CNTs is much higher along the tubes than across the tubes, and there is no energy loss when electrons transfer along the tubes. Second, higher gas permeability is expected with the aligned CNTs film. Third, the aligned film also exhibits super-hydrophobicity, which prevents water absorption within the fuel cell electrodes thereby improving the mass transport in a PEMFC. Fourth, elimination of PTFE without sacrificing hydrophobicity and electrode integrity enhances proton/electron conduction, leading to better catalyst utilization.

As a result, the elimination of the PTFE without sacrificing hydrophobicity and electrode integrity enabled by the disclosed materials maximizes transport and catalyst utilization. In the aligned CNTs nanoforest nanofilm structure assembled on carbon paper, the material itself maintains structural integrity and has good hydrophobicity. Hence, elimination of the PTFE in the electrode increases transport phenomena and utilization of catalyst.

To fabricate GDLs, the user may grow about 100 micrometer MWCNT on a silicon oxide substrate employing the CVD technique. A gaseous mixture of Ferrocene (0.1 g), as a catalyst source, and Xylene (10 mL), as a carbon source, was preheated to 185° C. and passed over the substrate placed inside the CVD furnace at 800° C. for 30 mins with the help of Ar gas. MWCNTs grew on the substrate with controlled thickness and length. Diluted hydrofluoric acid was used to etch the VA-CNT-NF from the silicon oxide substrate. The as-grown VA-CNT-NF has a thin layer of iron-based (Fe) catalyst film at its bottom, which is seen in the Scanning Electron Microscope (SEM) image shown in FIG. 1, and is suitably be removed.

To remove the thin Fe (Iron) catalyst layer from the VA-CNT-NF, an acid treatment method was used. The VA-CNT-NF was immersed in 37% hydrochloric (HCl) acid solution at room temperature for an hour, followed by rinsing with deionized water. Other disclosed methods of removing catalyst—described elsewhere herein—may also be used. After 5 cycles of similar treatment, the VA-CNT-NF was rinsed with distilled water several times and dried in a vacuum furnace for 1 hour. The sample at each step was analyzed using SEM and Energy Dispersive X-ray Spectroscopy (EDXS) to ensure that the thin Fe catalyst layer was entirely removed to establish the process and time needed to fully remove the Fe catalyst layers.

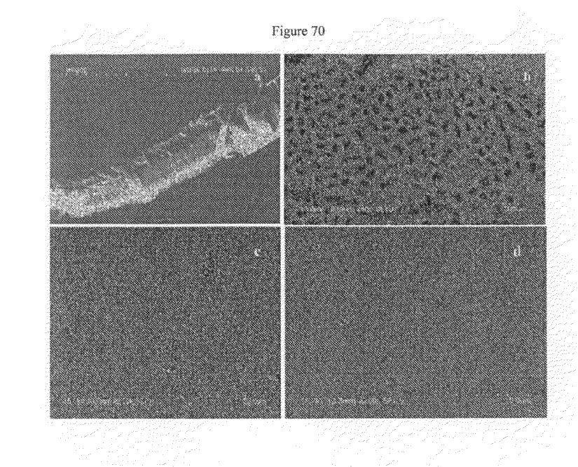

FIG. 70 depicts SEM images of the acid treated VA-CNT-NF after 5 hours of treatment.

While FIGS. 70a, 70b, and 70c depict the bottom surface of the VA-CNT-NF where the thin Fe catalyst layer is removed, FIG. 70d depicts the top surface of the VA-CNT-NF which is free from any impurities such as catalyst layer and amorphous carbon. The reaction time with the acid solution was the most critical parameter for optimal removal of the Fe catalyst particles from the bottom surface of the VA-CNT-NF without disturbing its structure.

When the Fe catalyst layer is entirely removed, the MWCNTs are held together by Van der Waal forces that maintain their integrity as a nanoforest nanotape, which is then placed on top of the carbon fiber without a Teflon™ coating to make the disclosed VA-CNT-NF GDL. In some embodiments, carbon paper (e.g., GD07508T, Hollingsworth and Vose Company, West Groton, Mass.) was cut into pieces small enough to fit into a furnace (F79300, Barnstead International) configured for Chemical Vapor Deposition (CVD). The carbon paper pieces were loaded into the heating zone of a quartz tube and heated to 770° C. in an argon atmosphere.

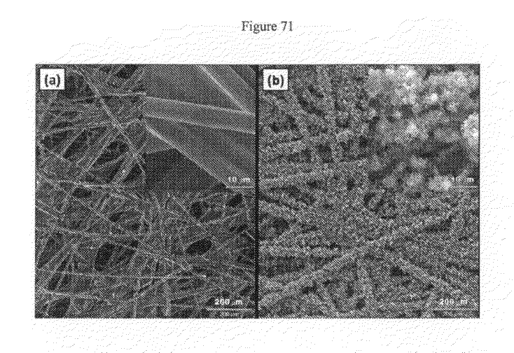

A mixture of 1 wt % (0.1 g) Ferrocence (Aldrich F408) in 10 mL Xylenes (Fisher X5) were used as a catalyst in a carbon source, respectively, for the growth of MWCNTs over the carbon paper. The modified carbon paper was directly assembled as the GDL in the PEMFC. Both the as-received and in-situ modified carbon papers were analyzed using the scanning election microscope (see FIG. 71).

FIG. 71b demonstrates the nature of the MWCNTs grown on the surface of the carbon fiber and it can be seen that the MWCNTs are not of vertical nature to truly resemble a “nanoforest” and, in fact, they resemble a bundle or a bush twisted with random orientations (see the inset in FIG. 4b). By contrast in the disclosed VA-CNT-NF, developed as the GDLs for PEM fuel cells, MWCNTs are well-aligned in the vertical direction (see FIG. 69).

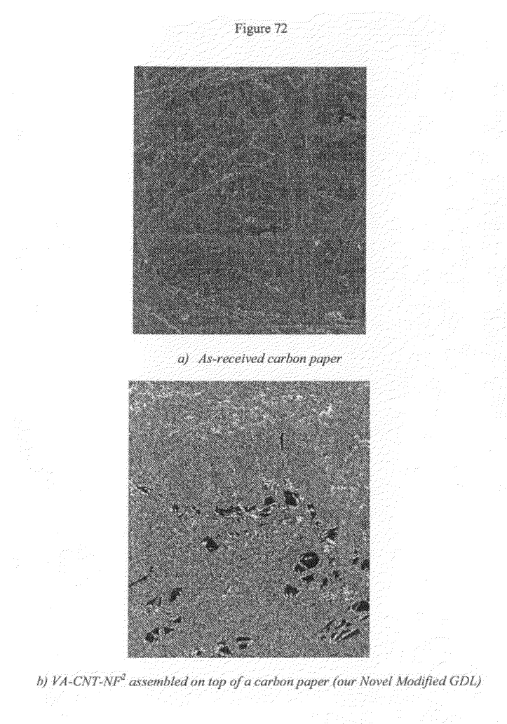

In the exemplary embodiments, carbon paper without PTFE coating was used as the base for VA-CNT-NF based GDL (see FIG. 72a). Therefore, acid-treated VA-CNT-NF was assembled on top of the carbon paper to make the GDL (see FIG. 72b). Catalyst coated membranes (CCMs) with 5 cm² active area were made using platinum supported on carbon made into catalyst slurry. Slurry was made by purging catalyst powder in flowing nitrogen gas for 30 minutes to avoid any decomposition. Slurry was applied to a Nafion® NRE-211 membrane (Ion Power Inc., New Castle, Del.) using a micro-spray technique. To improve the 3-phase zone of the reaction area, 15 wt % Nafion® solution (Ion Power Inc., New Castle, Del.) was added to the slurry. The CCM was dried in a vacuum oven at 50° C. for 30 minutes.

GDLs and CCM were assembled in a single test cell (Fuel Cell Technologies, Albuquerque, N. Mex., USA) by sandwiching them together with silicone-coated fabric (CF1007, Saint-Gobain Perfomace Plastics) to provide gas sealing. The cell was closed and tightened to a uniform torque of 40 lb-in. Cell performance was tested using galvanostatic polarization with Greenlight Test Station (G50 Fuel cell system, Hydrogenics, Vancouver, Canada). The cell was purged with nitrogen and tested at 70° C. with H₂/O₂ and H₂/air. Hydrogen gas was flowed over the anode at a rate of 0.2 SCCM and oxygen or air was flowed over the cathode at a rate of 0.4 SCCM. The humidity in the cell was controlled by adjusting the humidity bottle temperature.

Two cells were tested using this method, one with modified VA-CNT-NF carbon paper used as the novel GDL and the other using plain, as-received carbon paper as the GDL. All other components in the fuel cell were the same to provide an experimental cell that can be compared to a reference cell.

Since VA-CNT-NF assembled on the surface of the carbon paper are hydrophobic in nature, their presence on the surface of the in-situ modified carbon paper promotes hydrophobic properties. The contact angle for as-received paper was compared to that for the modified carbon papers.

Four different GDLs were evaluated: (1) As-received Teflonized™ carbon paper is referred to as Base 1 GDL; (2) in-situ modified CNT paper with MWCNT growth is referred to as Modified CVD GDL; (3) Plain carbon paper without any Teflonized™ coatings is referred as Base GDL; and (4) modified VA-CNT-NF GDL is referred to as Modified MWCNT GDL.

Contact angle testing was performed on a Kruss Drop Shape Analyzer DSA100 using 1.0 microliter droplets. The contact angles obtained using the 1 microliter droplets were not comparable to the values published in literature for GDLs. Advancing contact angle could not be used for contact angle measurements due to pin holes in the GDL.

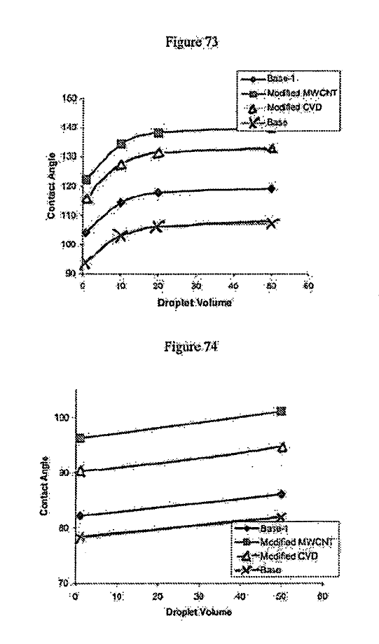

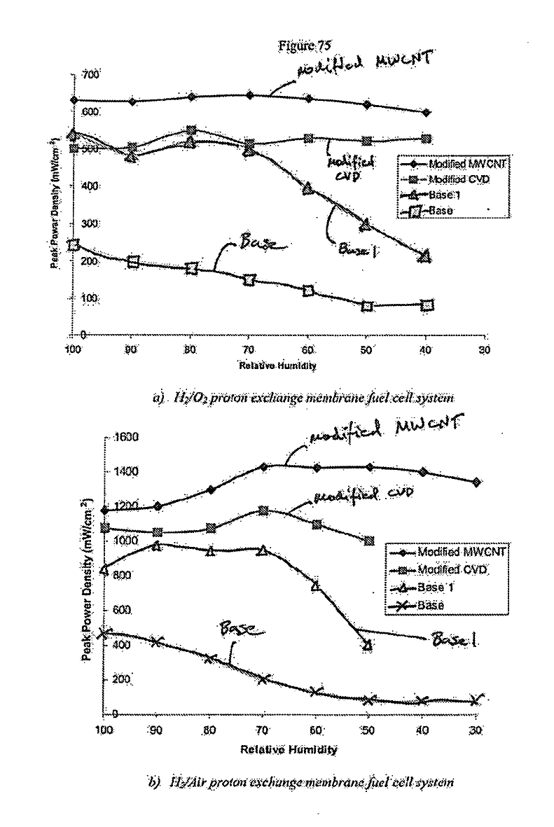

In order to attain a contact angle, which is closest to the Advancing Contact Angle, the drop size of the water droplet volume was increased until the contact angle reached a plateau (see FIG. 73), with the raw data given in Appendix A). Similar experimental readings were noted down for diiodomethane (see FIG. 74, with the raw data given in Appendix B), instead of water. As can be seen in these figures, in both cases, the degree of hydrophobicity (demonstrated by a higher contact angle) increases from Base, to Base 1, to Modified CVD, to Modified MWCNTs.

The average contact angles with water and diiodomethane were used along with the Fowkes theory to calculate the surface energies of the surfaces and presented in Table 13. Next, the average contact angles with water and diiodomethane were used along with an Equation of State approach to calculate surface energies of the surfaces as presented in Table 14.

TABLE 13
Surface energies of various GDLs using average contact angles
from FIGS. 6 and 7 employing Fowkes theory.

| Surface | Overall | | | |
|---|---|---|---|---|
| (based on | Surface | Polar | Dispersive | Surface |
| 50 microliter | Energy | Component | Component | Polarity |
| droplets) | (mJ/m²) | (mJ/m²) | (mJ/m²) | (%) |
| Modified MWCNT | 9.11 | 0.83 | 8.28 | 9.06 |
| Modified CVD | 11.30 | 0.56 | 10.74 | 4.92 |
| Base-1 | 14.51 | 0.02 | 14.49 | 0.11 |
| Base | 17.07 | 0.49 | 16.58 | 2.88 |

TABLE 14
Surface energies of various GDLs using average contact angles from
FIGS. 6 and 7 employing the Equation of State (EQS) approach.

| Surface | Overall Surface Energy | |
|---|---|---|
| (based on 50 microliter droplets) | (mJ/m²) | Beta |
| Modified MWCNT | 22.18 | 0.00060 |
| Modified CVD | 23.29 | 0.0005 |
| Base-1 | 26.57 | 0.00032 |
| Base | 29.05 | 0.000172 |

In general, the surface energy decreases as the hydrophobicity increases (or hydrophilicity decreases). As a result, the surface energy decreases for the GDLs from Base, to Base 1, to Modified CVD, to Modified MWCNT.

Polarization curves were generated while operating the cell at varying relative humidity (RH) values and the peak power density from each curve was generated and plotted in FIG. 75). It can be observed that as the RH decreases the behavior of as-received carbon paper (i.e., Base 1) fuel cell becomes unstable, whereas the in-situ modified carbon paper (i.e., Modified CVD) fuel cell demonstrates stability as the RH decreases. Carbon paper without any Teflonized™ coatings (i.e., Base) performs poorly, in general; particularly, at low RH conditions due to relatively no membrane humidity.

However, the disclosed GLDs perform the best due to improved electrical conductivity, higher gas permeability, higher contact angle, lower surface energy, and higher hydrophobicity as depicted by the results. Compared with previous CNT-based electrodes, the disclosed GDLs exhibit advantages. Eliminating PTFE form the carbon paper used as the base of the disclosed GDL was beneficial to the proton/electron conduction without sacrificing the electrode integrity and the GDL hydrophobicity (provided by VA-CNT-NF), thereby leading to a better transport and catalyst utilization.

The trend shows that the performance of the fuel cell using the Base 1 GDL (i.e., commonly used GDL in PEMFCs) is best at high humidity conditions, i.e., 100-70% relative humidity, and that the fuel cell performance falls with relative humidity below 70%. The in-situ Modified CVD GDL shows relatively sustained performance at both high and low humidity conditions in the testing range of 100-40% relative humidity. The Base GDL performs poorly due to the lack hydrophobicity and membrane humidity.

The Modified MWCNT GDL presented here performed well at all RH conditions. The elimination of insulating PTFE in the GDL improves the Pt utilization and further lowers the ohmic range. In the higher current density (i.e., in the mass controlled region), the MEA with the GDL with 0 wt % PTFE (i.e., Base GDL) in the cathode catalyst layer shows a much lower performance, which is mainly attributed to the ‘flooding’ of the electrode (i.e., not having hydrophobicity) and the consequent mass transport difficulties. By contrast, the disclosed GDLs with VA-CNT-NF have hydrophobic properties. Even without PTFE, the disclosed VA-CNT-NF GDL repels water/moisture from the electrode (due to the high level of MWCNTs hydrophobicity), and hence facilitates the reactant oxygen to diffuse to catalyst sites, resulting in a much better cell performance, as seen in FIG. 75). The optimization of the structure of the VA-CNT-NF thickness, Nafion™ content, etc., improves the power density of PEMFC further.

The performance enhancement at the lower relative humidity conditions for the novel VA-CNT-NF GDL is, without being bound to any single theory, due to the presence of the hydrophobic layer consisting of MWCNTs, which repels the water from the gas diffusion layer, and hence promotes the membrane hydration while still promoting gas exchange across the catalyst layer. Higher membrane hydration promotes proton conductivity across the membrane from the anode to the cathode. In addition, the MWCNTS present enhanced electrical conductivity.

The modified GDL using VA-CNT-NF shows excellent performance over a wide range of humidity conditions, including lower humidity when compared with plain as-received Teflonized™ carbon paper currently used in PEMFCs. The performance of fuel cells that operate with atmospheric air, unstable humidity conditions, or with simplified humidification systems is significantly enhanced using the MWCNT gas diffusion layer developed here. The provided GDLs thus (1) require lower humidity due to its hydrophobic nature that repels humidity towards the PEM, hence reducing the size, weight, and cost of the humidity generator, (2) lasts longer since they do not absorb humidity, and hence does not degrade in performance over time, (3) provide better electrical conductivity, and (4) increase peak power density.

APPENDIX A
(Details of the Water Contact Angle Tests)

| | | | | |
|---|---|---|---|---|
| | | Modified | Modified | |
| | Base-1 | MWCNT | CVD | Base |
| Drop # | (degrees) | (degrees) | (degrees) | (degrees) |

Water Contact Angles Drops are 1.0 Microliters

| | | | | |
|---|---|---|---|---|
| 1 | 103.7 | 122.6 | 115.8 | 93.4 |
| 2 | 104.6 | 122.3 | 115.5 | 93.6 |
| 3 | 104.1 | 121.7 | 116.1 | 93.7 |
| 4 | 104.0 | 122.5 | 116.2 | 94.1 |
| 5 | 104.2 | 121.7 | 116.1 | 93.8 |
| 6 | 103.7 | 122.2 | 115.8 | 94.2 |
| 7 | 104.2 | 121.9 | 115.8 | 93.4 |
| 8 | 104.1 | 121.9 | 115.6 | 93.4 |
| 9 | 103.7 | 121.7 | 115.8 | 93.7 |
| 10 | 104.2 | 122.3 | 116.3 | 93.9 |
| Average | 104.1 | 122.1 | 115.9 | 93.7 |
| Std. Dev. | 0.3 | 0.3 | 0.3 | 0.3 |

Water Contact Angles Drops are 10.0 Microliters

| | | | | |
|---|---|---|---|---|
| 1 | 114.5 | 133.9 | 127.3 | 103.2 |
| 2 | 114.0 | 134.7 | 127.4 | 103.4 |
| 3 | 114.5 | 133.8 | 127.6 | 102.8 |
| 4 | 114.4 | 134.1 | 127.9 | 103.5 |
| 5 | 114.7 | 134.5 | 127.3 | 103.2 |
| 6 | 114.2 | 134.6 | 127.4 | 102.9 |
| 7 | 114.7 | 134.5 | 127.4 | 103.4 |
| 8 | 114.6 | 134.5 | 127.9 | 102.8 |
| 9 | 114.2 | 134.7 | 127.9 | 102.6 |
| 10 | 114.3 | 134.2 | 127.0 | 102.8 |
| Average | 114.4 | 134.4 | 127.5 | 103.1 |
| Std. Dev. | 0.2 | 0.3 | 0.3 | 0.3 |

Water Contact Angles Drops are 20.0 Microliters

| | | | | |
|---|---|---|---|---|
| 1 | 118.1 | 138.6 | 131.6 | 106.3 |
| 2 | 117.6 | 138.2 | 131.1 | 106.2 |
| 3 | 117.9 | 138.3 | 131.5 | 106.0 |
| 4 | 117.5 | 138.7 | 131.5 | 106.4 |
| 5 | 118.2 | 138.0 | 131.1 | 106.1 |
| 6 | 117.4 | 138.7 | 131.6 | 106.3 |
| 7 | 117.8 | 138.4 | 131.0 | 105.8 |
| 8 | 118.1 | 138.6 | 131.5 | 106.3 |
| 9 | 117.6 | 138.2 | 131.4 | 106.5 |
| 10 | 117.7 | 138.2 | 131.5 | 105.7 |
| Average | 117.8 | 138.4 | 131.4 | 106.2 |
| Std. Dev. | 0.3 | 0.2 | 0.2 | 0.3 |

Water Contact Angles Drops are 50.0 Microliters

| | | | | |
|---|---|---|---|---|
| 1 | 119.5 | 140.0 | 132.5 | 107.1 |
| 2 | 119.2 | 139.5 | 132.2 | 107.0 |
| 3 | 118.8 | 139.6 | 132.7 | 107.6 |
| 4 | 119.0 | 139.3 | 132.2 | 107.0 |
| 5 | 119.4 | 139.4 | 132.9 | 106.9 |
| 6 | 119.2 | 140.2 | 132.3 | 107.1 |
| 7 | 118.9 | 139.7 | 132.4 | 107.1 |
| 8 | 119.0 | 140.2 | 132.4 | 107.7 |
| 9 | 119.0 | 139.9 | 133.1 | 106.7 |
| 10 | 118.7 | 140.1 | 132.9 | 106.7 |
| Average | 119.1 | 139.8 | 132.6 | 107.1 |
| Std. Dev. | 0.3 | 0.3 | 0.3 | 0.3 |

APPENDIX B
(Details of the Diiodomethane Contact Angle Tests)

| | | | | |
|---|---|---|---|---|
| | | Modified | Modified | |
| | Base-1 | MWCNT | CVD | Base |
| Drop # | (degrees) | (degrees) | (degrees) | (degrees) |

Diiodomethane Contact Angles Drops are 1.0 Microliters

| | | | | |
|---|---|---|---|---|
| 1 | 82.5 | 96.6 | 90.4 | 77.9 |
| 2 | 81.8 | 95.9 | 90.1 | 78.1 |
| 3 | 81.8 | 96.3 | 90.0 | 77.9 |
| 4 | 81.9 | 96.3 | 90.6 | 78.6 |
| 5 | 82.4 | 96.2 | 90.6 | 78.6 |
| 6 | 82.0 | 96.6 | 89.9 | 78.2 |
| 7 | 82.3 | 95.8 | 90.2 | 78.3 |
| 8 | 82.1 | 96.6 | 90.6 | 78.0 |
| 9 | 82.7 | 96.6 | 90.3 | 78.3 |
| 10 | 82.4 | 96.5 | 90.3 | 77.8 |
| Average | 82.2 | 96.3 | 90.3 | 78.2 |
| Std. Dev. | 0.3 | 0.3 | 0.3 | 0.3 |

Diiodomethane Contact Angles Drops are 50.0 Microliters

| | | | | |
|---|---|---|---|---|
| 1 | 86.4 | 101.3 | 94.2 | 81.4 |
| 2 | 86.1 | 100.6 | 94.3 | 81.6 |
| 3 | 85.9 | 101.3 | 95.0 | 81.6 |
| 4 | 86.0 | 101.4 | 95.1 | 82.1 |
| 5 | 86.2 | 101.3 | 94.6 | 82.2 |
| 6 | 86.3 | 101.0 | 94.8 | 81.7 |
| 7 | 85.7 | 101.3 | 94.2 | 81.7 |
| 8 | 86.0 | 101.4 | 95.0 | 82.2 |
| 9 | 85.7 | 100.4 | 94.6 | 81.5 |
| 10 | 86.5 | 101.1 | 94.4 | 81.7 |
| Average | 86.1 | 101.1 | 94.6 | 81.8 |
| Std. Dev. | 0.3 | 0.3 | 0.3 | 0.3 |

1. A method of fabricating a composite material, comprising:
disposing nanostructures having major axes onto a support surface,
removing from the surface a film comprising at least some of the nanostructures;
aligning at least some of the nanostructures of the film such that the major axes of the aligned nanostructures are substantially parallel to the plane of the film, and
positioning the film atop a first surface; and
affixing the first surface to a second surface to form an interface between the first and second surfaces,
the interface comprising the film of nanostructures.

2. The method of claim 1, wherein the support surface comprises silicon oxide, silicon, quartz, or any combination thereof.

3. The method of claim 1, wherein a nanostructure comprises a nanotube, a nanosheet, a nanofiber, or any combination thereof.

4. The method of claim 1, wherein the nanostructure comprises a characteristic dimension in the range of from about 1 nm to about 100 nm.

5. The method of claim 1, wherein the film defines a thickness in the range of from about 20 micrometers to about 100 micrometers.

6-7. (canceled)

8. The method of claim 1, wherein the disposing comprises growing the nanostructures.

9-12. (canceled)

13. The method of claim 1, wherein the removing comprises application of hydrofluoric acid, a phosphoric acid, or any combination thereof.

14. (canceled)

15. The method of claim 1, wherein the aligning comprises application of mechanical force.

16-24. (canceled)

25. A method of fabricating a composite article, comprising:
positioning a film of nanostructures having major axes between a first surface and a second surface,
the major axes aligned essentially parallel to the plane of the film; and
affixing the first and second surfaces to one another to form an interface between the first and second surfaces, the interface comprising the film of nanostructures.

26. The method of claim 25, wherein a nanostructure comprises a nanotube, a nanosheet, a nanofiber, or any combination thereof.

27-30. (canceled)

31. The method of claim 25, wherein at least one of the first surface and second surface comprises a fiber, a prepreg, a weave, triaxial, tow, tape, mat, braided or any combination thereof.

32. A composite article, comprising:
a film of nanostructures having major axes disposed at the interface between a first surface and a second surface,
the major axes of the nanostructures being aligned substantially parallel to the plane of the film.

33. The composite article of claim 32, wherein a nanostructure comprises a nanotube, a nanosheet, a nanofiber, or any combination thereof.

34. The composite article of claim 32, wherein a nanotube comprises a carbon nanotube.

35. The composite article of claim 32, wherein the film defines a thickness of from about 1 to about 500 micrometers.

36-38. (canceled)

39. The composite article of claim 32, wherein the first surface, the second surface, or both, comprises a fiber, a prepreg, a weave, textile, tow, tape, mat, braided, or any combination thereof.

40. The composite article of claim 32, wherein the first surface, the second surface, or both, comprises a polymer.

41. The composite article of claim 32, wherein the major axes of the nanostructures are aligned essentially parallel to the first surface, the second surface, or both.

42. The composite article of claim 32, wherein one or more nanostructure is at least partially embedded in the first surface, the second surface, or both.

43. The composite article of claim 32, wherein the composite article exhibits an improved thermal conductivity, an improved mechanical strength, an improved mechanical toughness, an improved damping, a reduced coefficient of thermal expansion, an improved shielding of electromagnetic interference, or any combination thereof, relative to an essentially identical composite article lacking the film of nanostructures, under essentially identical conditions.

44. A composite article, comprising:
a body having a surface at least partially surmounted by a film,
the film comprising a plurality of nanostructures having major axes oriented substantially parallel to the plane of the film.

45. The composite article of claim 44, wherein a nanostructure comprises a nanotube, a nanosheet, a nanofiber, or any combination thereof.

46. The composite article of claim 44, wherein a nanotube comprises a carbon nanotube.

47-50. (canceled)

51. The composite article of claim 44, wherein the body comprises a fiber, a prepreg, a weave, textile, tow, tape, mat, braided, or any combination thereof.

52-53. (canceled)

54. The composite article of claim 44, wherein the composite article exhibits an improved thermal conductivity, an improved mechanical strength, an improved mechanical toughness, an improved damping, a reduced coefficient of thermal expansion, an improved shielding of electromagnetic interference, or any combination thereof, relative to an essentially identical composite article lacking the film of nanostructures, under essentially identical conditions.

55-59. (canceled)

60. A method of fabricating a nanostructure film, comprising:
growing nanostructures having major axes on a support substrate so as to give rise to a population of nanostructures;
removing from the support substrate a film comprising at least some of the nanostructures; and
aligning at least some of the nanostructures of the film such that the major axes of the aligned nanostructures are substantially parallel to the plane of the film.

61. The method of claim 60, wherein a nanostructure comprises a nanotube, a nanosheet, a nanofiber, or any combination thereof.

62-65. (canceled)

66. The method of claim 60, wherein the aligning comprises application of mechanical force.

67-68. (canceled)

69. A reinforcement material, comprising:
a film of nanostructures having major axes,
the major axes aligned essentially parallel to the plane of the film.

70. The reinforcement material of claim 69, wherein a nanostructure comprises a nanotube, a nanosheet, a nanofiber, or any combination thereof.

71-90. (canceled)
